(19) United States
(12) Patent Application Publication
(10) Pub. No.: US 2013/0202197 A1
(43) Pub. Date: Aug. 8, 2013

(54) System and Method for Manipulating Data Having Spatial Co-ordinates

(71) Applicants: Edmund Cochrane Reeler, Ottawa (CA); Kresimir Kusevic, Ottawa (CA); Dmitry Kulakov, Ottawa (CA); James Andrew Estill, New York, NY (US); Borys Vorobyov, Gloucester (CA); Oleksandr Monastyrev, Kharkiv (UA); Dmytro Gordon, Kharkiv (UA); Yuriy Monastyrev, Kharkiv (UA); Andrey Zaretskiy, Kharkiv (UA)

(72) Inventors: Edmund Cochrane Reeler, Ottawa (CA); Kresimir Kusevic, Ottawa (CA); Dmitry Kulakov, Ottawa (CA); James Andrew Estill, New York, NY (US); Borys Vorobyov, Gloucester (CA); Oleksandr Monastyrev, Kharkiv (UA); Dmytro Gordon, Kharkiv (UA); Yuriy Monastyrev, Kharkiv (UA); Andrey Zaretskiy, Kharkiv (UA)

(21) Appl. No.: 13/703,550

(22) PCT Filed: Jun. 10, 2011
(86) PCT No.: PCT/CA2011/000672

§ 371 Date: Apr. 19, 2013

Related U.S. Application Data
(60) Provisional application No. 61/353,939, filed on Jun. 11, 2010.

(51) Int. Cl. G06T 15/20; G06F 21/10; G06K 9/00

(52) U.S. Cl. CPC G06T 15/20; G06K 9/00201; G06F 21/105
USPC 382/154; 345/427; 726/29

(57) ABSTRACT

Systems and methods are provided for extracting various features from data having spatial coordinates. The systems and methods may identify and extract data points from a point cloud, where the data points are considered to be part of the ground surface, a building, or a wire (e.g. power lines). Systems and methods are also provided for enhancing a point cloud using external data (e.g. images and other point clouds), and for tracking a moving object by comparing images with a point cloud. An objects database is also provided which can be used to scale point clouds to be of similar size. The objects database can also be used to search for certain objects in a point cloud, as well as recognize unidentified objects in a point cloud.

### CROSS-REFERENCE TO RELATED APPLICATIONS

The present application claims priority to U.S. Provisional Application No. 61/353,939 filed Jun. 11, 2010 hereby incorporated by reference in its entirety.

### TECHNICAL FIELD

The following relates generally to manipulating data representing spatial coordinates.

### DESCRIPTION OF THE RELATED ART

In order to investigate an object or structure, it is known to interrogate the object or structure and collect data resulting from the interrogation. The nature of the interrogation will depend on the characteristics of the object or structure. The interrogation will typically be a scan by a beam of energy propagated under controlled conditions. The results of the scan are stored as a collection of data points, and the position of the data points in an arbitrary frame of reference is encoded as a set of spatial-coordinates. In this way, the relative positioning of the data points can be determined and the required information extracted from them.

Data having spatial coordinates may include data collected by electromagnetic sensors of remote sensing devices, which may be of either the active or the passive types. Non-limiting examples include LiDAR (Light Detection and Ranging), RADAR, SAR (Synthetic-aperture RADAR), IFSAR (Interferometric Synthetic Aperture Radar) and Satellite Imagery. Other examples include various types of 3D scanners and may include sonar and ultrasound scanners.

LiDAR refers to a laser scanning process which is usually performed by a laser scanning device from the air, from a moving vehicle or from a stationary tripod. The process typically generates spatial data encoded with three dimensional spatial data coordinates having XYZ values and which together represent a virtual cloud of 3D point data in space or a “point cloud”. Each data element or 3D point may also include an attribute of intensity, which is a measure of the level of reflectance at that spatial data coordinate, and often includes attributes of RGB, which are the red, green and blue color values associated with that spatial data coordinate. Other attributes such as first and last return and waveform data may also be associated with each spatial data coordinate. These attributes are useful both when extracting information from the point cloud data and for visualizing the point cloud data. It can be appreciated that data from other types of sensing devices may also have similar or other attributes.

The visualization of point cloud data can reveal to the human eye a great deal of information about the various objects which have been scanned. Information can also be manually extracted from the point cloud data and represented in other forms such as 3D vector points, lines and polygons, or as 3D wire frames, shells and surfaces. These forms of data can then be input into many existing systems and workflows for use in many different industries including for example, engineering, architecture, construction and surveying.

A common approach for extracting these types of information from 3D point cloud data involves subjective manual pointing at points representing a particular feature within the point cloud data either in a virtual 3D view or on 2D plans, cross sections and profiles. The collection of selected points is then used as a representation of an object. Some semi-automated software and CAD tools exist to streamline the manual process including snapping to improve pointing accuracy and spline fitting of curves and surfaces. Such a process is tedious and time consuming. Accordingly, methods and systems that better semi-automate and automate the extraction of these geometric features from the point cloud data are highly desirable.

Automation of the process is, however, difficult as it is necessary to recognize which data points form a certain type of object. For example, in an urban setting, some data points may represent a building, some data points may represent a tree, and some data points may represent the ground. These points coexist within the point cloud and their segregation is not trivial.

From the above it can be understood that efficient and automated methods and systems for identifying and extracting features from 3D spatial coordinate data are highly desirable.

### BRIEF DESCRIPTION OF THE DRAWINGS

Embodiments of the invention or inventions will now be described by way of example only with reference to the appended drawings wherein:

FIG. 1 is a schematic diagram to illustrate an example of an aircraft and a ground vehicle using sensors to collect data points of a landscape.

FIG. 2 is a block diagram of an example embodiment of a computing device and example software components.

FIG. 3 is a flow diagram illustrating example computer executable instructions for extracting features from a point cloud.

FIG. 4 is a flow diagram illustrating example computer executable instructions for extracting a ground surface from a point cloud.

FIG. 5 is a flow diagram illustrating example computer executable instructions continued from FIG. 4.

FIG. 6 is a flow diagram illustrating example computer executable instructions continued from FIG. 5.

FIG. 7 is a schematic diagram illustrating an example ground surface and the example measurements of various parameters to extract the ground surface from a point cloud.

FIG. 8 is a flow diagram illustrating example computer executable instructions for extracting a building from a point cloud.

FIG. 9 is a top-down plane view of a visualization of an exemplary point cloud.

FIG. 10 is a top-down plane view of a building extracted from the exemplary point cloud in FIG. 9.

FIG. 11 is a perspective view of the building extracted from the example point cloud in FIG. 9.

FIG. 12 is a flow diagram illustrating example computer executable instructions for separating vegetation from buildings in a point cloud.

FIG. 13 is a flow diagram illustrating example computer executable instructions for reconstructing a building model from “building” points extracted from a point cloud.

FIG. 14 is a flow diagram illustrating example computer executable instructions continued from FIG. 13.

FIG. 15 is a perspective view of example “building points” extracted from a point cloud.

FIG. 16 is an example histogram of the distribution of points at various heights.

FIG. 17 is a schematic diagram illustrating an example stage in the method for reconstructing a building model, showing one or more identified layers having different heights.

FIG. 18 is a schematic diagram illustrating another example stage in the method for reconstructing a building model, showing the projection of the layers' boundary line to form walls.

FIG. 19 is a schematic diagram illustrating another example stage in the method for reconstructing a building model, showing the projected walls, ledges, and roofs of a building.

FIG. 20 is a perspective view of an example building reconstructed from the building points in FIG. 15.

FIG. 21 is a flow diagram illustrating example computer executable instructions for extracting wires from a point cloud.

FIG. 22 is a flow diagram illustrating example computer executable instructions continued from FIG. 21.

FIG. 23 is a flow diagram illustrating example computer executable instructions continued from FIG. 22.

FIG. 24 is a schematic diagram illustrating an example stage in the method for extracting wires, showing segments of a principal wire extracted from a point cloud.

FIG. 25 is a schematic diagram illustrating another example stage in the method for extracting wires, showing the projection of non-classified points onto a plane, whereby the plane is perpendicular to the principal wire.

FIG. 26 is a schematic diagram illustrating another example stage in the method for extracting wires, showing the projection of non-classified points onto a plane to identify wires.

FIG. 27 is a flow diagram illustrating example computer executable instructions for extracting wires in a noisy environment from a point cloud.

FIG. 28 is a flow diagram illustrating example computer executable instructions continued from FIG. 27.

FIGS. 29(a) through (e) are a series of schematic diagrams illustrating example stages in the method for extracting wires in a noisy environment, showing: a wire segment in FIG. 29(a); an origin point and Y-axis added to the wire segment in FIG. 29(b); an X-axis and a Z-axis added to the wire segment in FIG. 29(c); a first and a second polygon constructed around an end of the wire segment in FIG. 29(d); a proposed wire extension in FIG. 29(e); and, an extended wire segment including the proposed wire extension in FIG. 29(f).

FIG. 30 is a flow diagram illustrating example computer executable instructions for extracting relief and terrain features from a ground surface of a point cloud.

FIG. 31 is a flow diagram illustrating example computer executable instructions continued from FIG. 30.

FIG. 32 is a schematic diagram illustrating a camera device capturing an image of a scene.

FIG. 33 is a schematic diagram illustrating the image captured in FIG. 32.

FIG. 34 is an illustration of a point cloud base model showing the scene in FIG. 32.

FIG. 35 is a flow diagram illustrating example computer executable instructions for enhancing a base model using an image.

FIG. 36 is a flow diagram illustrating example computer executable instructions continued from FIG. 35.

FIG. 37 is a flow diagram illustrating example computer executable instructions for enhancing a base model using ancillary data points having spatial coordinates.

FIGS. 38(a) through (c) are a series of schematic diagrams illustrating example stages in the method for enhancing a base model using ancillary data points having spatial coordinates, showing: a base model in FIG. 38(a); the base model and transformed ancillary data points in FIG. 38(b); and, the base model having interpolated values based on the data of the transformed ancillary data points in FIG. 38(c).

FIG. 39 is a schematic diagram of a tracking point in an image at a first time and a corresponding point cloud showing a first new data point corresponding to the tracking point.

FIG. 40 is a schematic diagram of the tracking point in an image at a second time and the corresponding point cloud showing a second new data point corresponding to the tracking point.

FIG. 41 is a schematic diagram of the tracking point in an image at a third time and the corresponding point cloud showing a third new data point corresponding to the tracking point.

FIG. 42 is a flow diagram illustrating example computer executable instructions for tracking movement using a series of images and a base model.

FIG. 43 is a flow diagram illustrating example computer executable instructions continued from FIG. 42.

FIG. 44 is a schematic diagram of a data licensing module interacting with a user's computer.

FIG. 45 is a flow diagram illustrating example computer executable instructions for generating a data installation package.

FIG. 46 is a flow diagram illustrating example computer executable instructions for a user's computer receiving an installation package and determining if access to the data is allowed or denied.

FIG. 47 is a flow diagram illustrating example computer executable instructions for generating derivatives of licensed data, the derivatives including their own license.

FIG. 48 is a flow diagram illustrating another set of example computer executable instructions for determining if access to the data is allowed or denied.

FIG. 49 is a schematic diagram of an example configuration of an objects database.

FIG. 50 is a flow diagram illustrating example computer executable instructions for scaling an external point cloud to have approximately congruent proportions with a base model.

FIG. 51 is a flow diagram illustrating example computer executable instructions for searching for a certain object in a point cloud.

FIG. 52 is a flow diagram illustrating example computer executable instructions for recognizing an unidentified object in a point cloud.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The proposed systems and methods extract various features from data having spatial coordinates. Non-limiting examples of such features include the ground surface, buildings, building shapes, vegetation, and power lines. The extraction of the features may be carried out automatically by a computing device. The extracted features may be stored as objects for retrieval and analysis.

As discussed above, the data may be collected from various types of sensors. A non-limiting example of such a sensor is the LiDAR system built by Ambercore Software Inc. and available under the trade-mark TITAN.

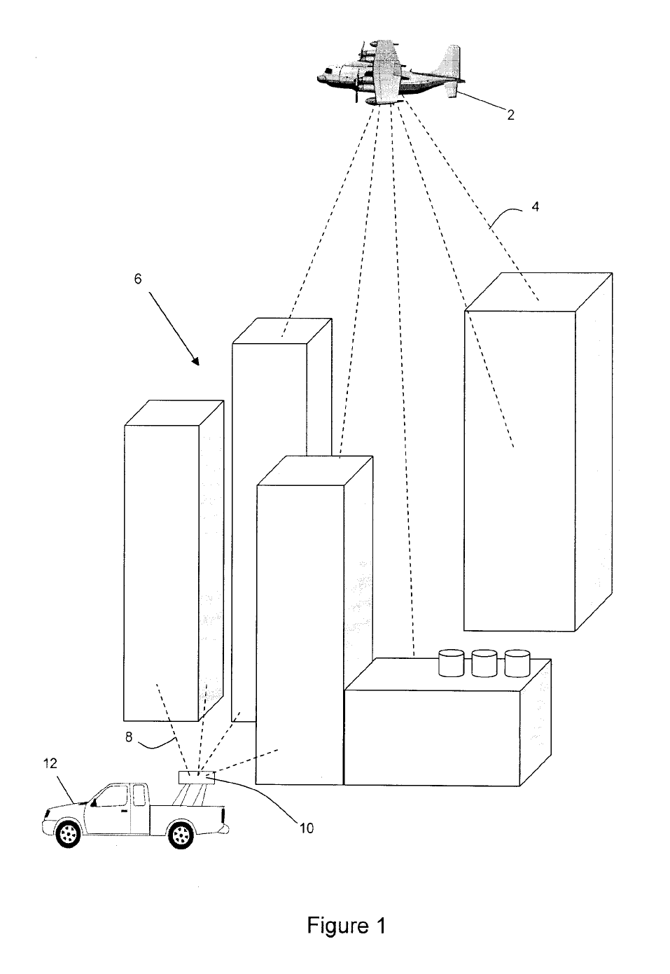

Turning to FIG. 1, data is collected using one or more sensors 10 mounted to an aircraft 2 or to a ground vehicle 12. The aircraft 2 may fly over a landscape 6 (e.g. an urban landscape, a suburban landscape, a rural or isolated landscape) while a sensor collects data points about the landscape 6. For example, if a LiDAR system is used, the LiDAR sensor 10 would emit lasers 4 and collect the laser reflection. Similar principles apply when an electromagnetic sensor 10 is mounted to a ground vehicle 12. For example, when the ground vehicle 12 drives through the landscape 6, a LiDAR system may emit lasers 8 to collect data. It can be readily understood that the collected data may be stored onto a memory device. Data points that have been collected from various sensors (e.g. airborne sensors, ground vehicle sensors, stationary sensors) can be merged together to form a point cloud.

Each of the collected data points is associated with respective spatial coordinates which may be in the form of three dimensional spatial data coordinates, such as XYZ Cartesian coordinates (or alternatively a radius and two angles representing Polar coordinates). Each of the data points also has numeric attributes indicative of a particular characteristic, such as intensity values, RGB values, first and last return values and waveform data, which may be used as part of the filtering process. In one example embodiment, the RGB values may be measured from an imaging camera and matched to a data point sharing the same coordinates.

The determination of the coordinates for each point is performed using known algorithms to combine location data, e.g. GPS data, of the sensor with the sensor readings to obtain a location of each point with an arbitrary frame of reference.

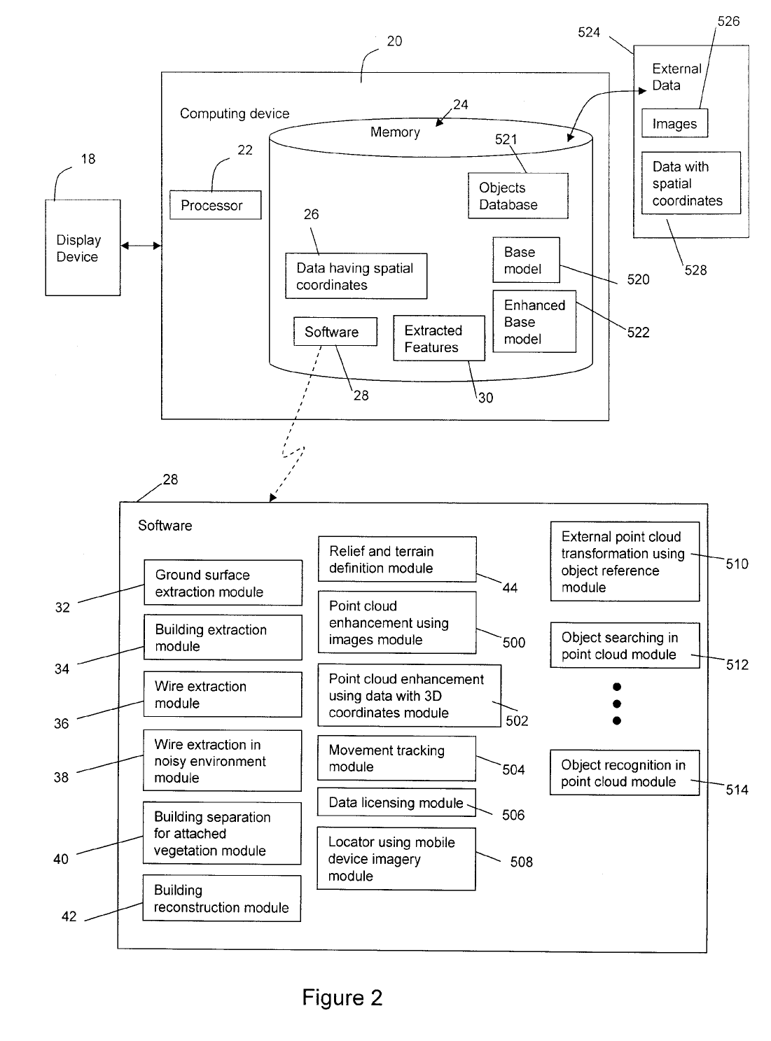

Turning to FIG. 2, a computing device 20 includes a processor 22 and memory 24. The memory 24 communicates with the processor 22 to process data. It can be appreciated that various types of computer configurations (e.g. networked servers, standalone computers, cloud computing, etc.) are applicable to the principles described herein. The data having spatial coordinates 26 and various software 28 reside in the memory 24. A display device 18 may also be in communication with the processor 22 to display 2D or 3D images based on the data having spatial coordinates 26.

It can be appreciated that the data 26 may be processed according to various computer executable operations or instructions stored in the software. In this way, the features may be extracted from the data 26.

Continuing with FIG. 2, the software 28 may include a number of different modules for extracting different features from the data 26. For example, a ground surface extraction module 32 may be used to identify and extract data points that are considered the “ground”. A building extraction module 34 may include computer executable instructions or operations for identifying and extracting data points that are considered to be part of a building. A wire extraction module 36 may include computer executable instructions or operations for identifying and extracting data points that are considered to be part of an elongate object (e.g. pipe, cable, rope, etc.), which is herein referred to as a wire. Another wire extraction module 38 adapted for a noisy environment 38 may include computer executable instructions or operations for identifying and extracting data points in a noisy environment that are considered to be part of a wire. The software 28 may also include a module 40 for separating buildings from attached vegetation. Another module 42 may include computer executable instructions or operations for reconstructing a building. There may also be a relief and terrain definition module 44. Some of the modules use point data of the buildings' roofs. For example, modules 34, 40 and 42 use data points of a building's roof and, thus, are likely to use data points that have been collected from overhead (e.g. an airborne sensor).

It can be appreciated that there may be many other different modules for extracting features from the data having spatial coordinates 26.

Continuing with FIG. 2, the features extracted from the software 28 may be stored as data objects in an “extracted features” database 30 for future retrieval and analysis. For example, features (e.g. buildings, vegetation, terrain classification, relief classification, power lines, etc.) that have been extracted from the data (e.g. point cloud) 26 are considered separate entities or data objects, which are stored the database 30. It can be appreciated that the extracted features or data objects may be searched or organized using various different approaches.

Also shown in the memory 24 is a database 520 storing one or more base models. There is also a database 522 storing one or more enhanced base models. Each base model within the base model database 520 comprises a set of data having spatial coordinates, such as those described with respect to data 26. A base model may also include extracted features 30, which have been extracted from the data 26. As will be discussed later below, a base model 522 may be enhanced with external data 524, thereby creating enhanced base models. Enhanced base models also comprise a set of data having spatial coordinates, although some aspect of the data is enhanced (e.g. more data points, different data types, etc.). The external data 524 can include images 526 (e.g. 2D images) and ancillary data having spatial coordinates 528.

An objects database 521 is also provided to store objects associated with certain base models. An object, comprising a number of data points, a wire frame, or a shell, has a known shape and known dimensions. Non-limiting examples of objects include buildings, wires, trees, cars, shoes, light poles, boats, etc. The objects may include those features that have been extracted from the data having spatial coordinates 26 and stored in the extracted features database 30. The objects may also include extracted features from a base model or enhanced base model.

FIG. 2 also shows that the software 28 includes a module 500 for point cloud enhancement using images. The software 28 also includes a module 502 for point cloud enhancement using data with 3D coordinates. There may also be a module 504 for movement tracking (e.g. monitoring or surveillance). There may also be another module 506 for licensing the data (e.g. the data in the databases 25, 30, 520 and 522). The software 28 also includes a module 508 for determining the location of a mobile device or objects viewed by a mobile device based on the images captured by the mobile device. There may also be a module 510 for transforming an external point cloud using an object reference, such as an object from the objects database 521. There may also be a module 512 for searching for an object in a point cloud. There may also be a module 514 for recognizing an unidentified object in a point cloud. It can be appreciated that there may be many other different modules for manipulating and using data having spatial coordinates. It can also be understood that many of the modules described herein can be combined with one another.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing device 20 or accessible or connectable thereto. Any application or module herein described may be implemented using computer readable/executable instructions or operations that may be stored or otherwise held by such computer readable media.

Details regarding the different feature extraction systems and methods, that may be associated with the various modules in the software 28, will now be discussed.

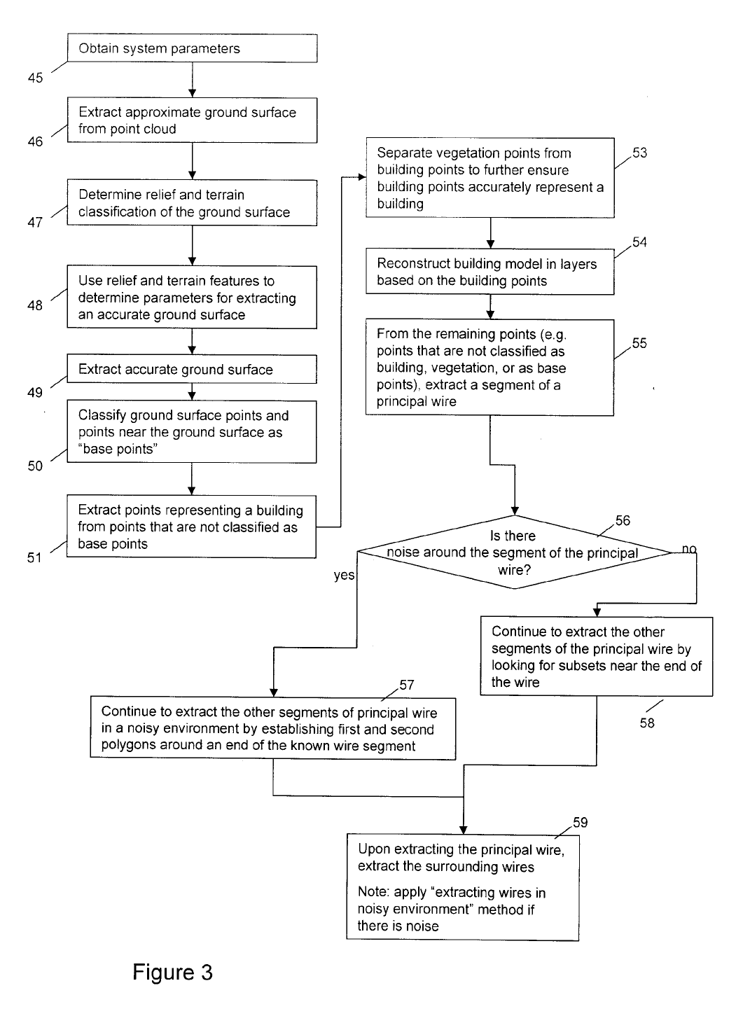

Turning to FIG. 3, example computer executable instructions are provided for extracting various features from a point cloud. The various operations often require system parameters, which may be inputted manually or obtained from a database. These parameters are used to tune or modify operational characteristics of the various algorithms. Non-limiting examples of the operational characteristics include sensitivity, resolution, efficiency, thresholds, etc. The values of the parameters are typically selected to suit the expected types of environment that the point cloud may represent. Thus, at block 45, system parameters are obtained. Although not shown, the parameters may also be obtained throughout the different extraction stages. For example, before executing the instructions of each module, the values of the relevant parameters pertaining to the respective model are obtained.

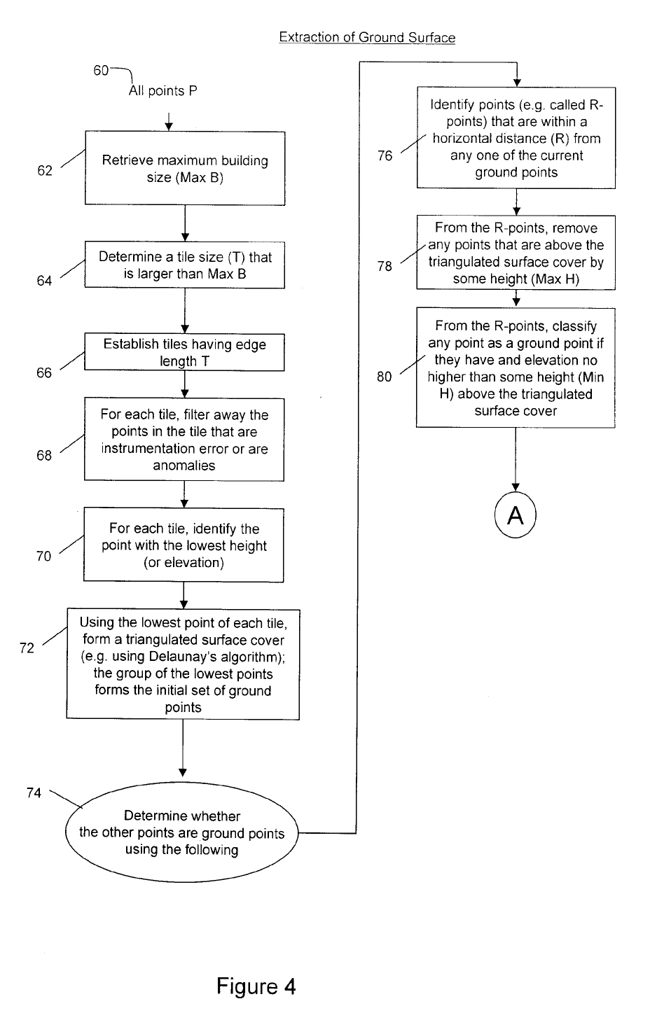

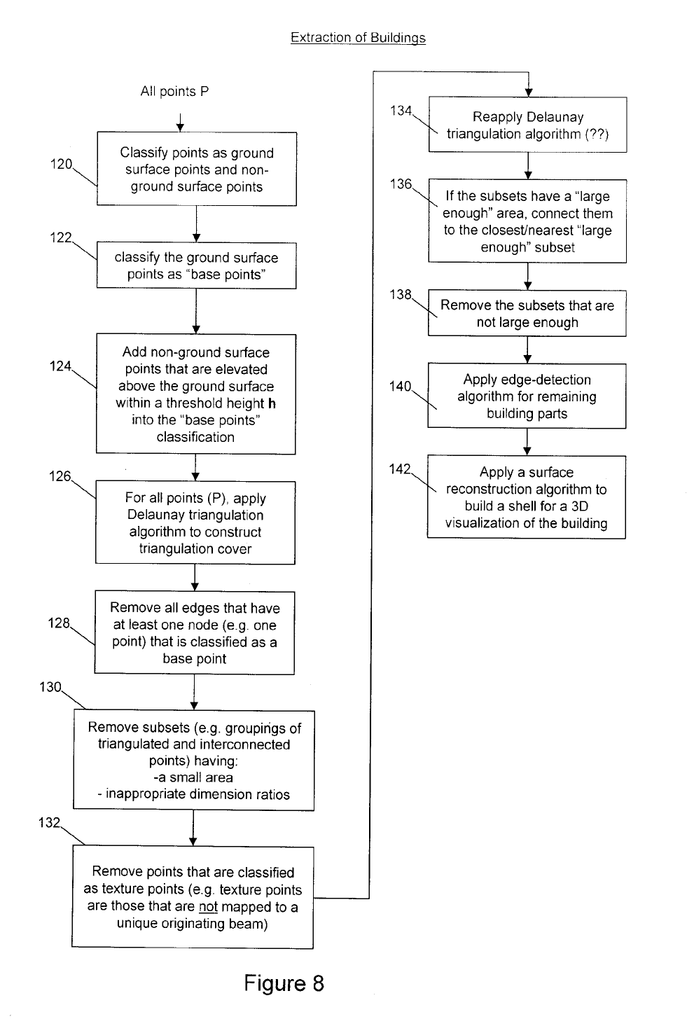

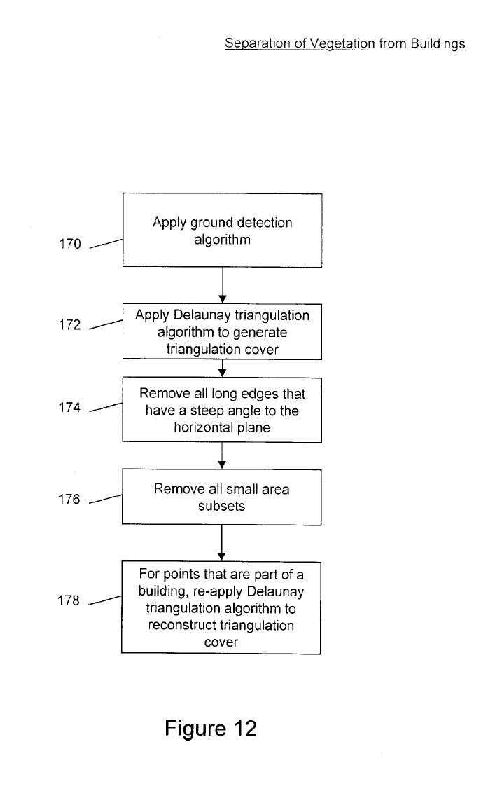

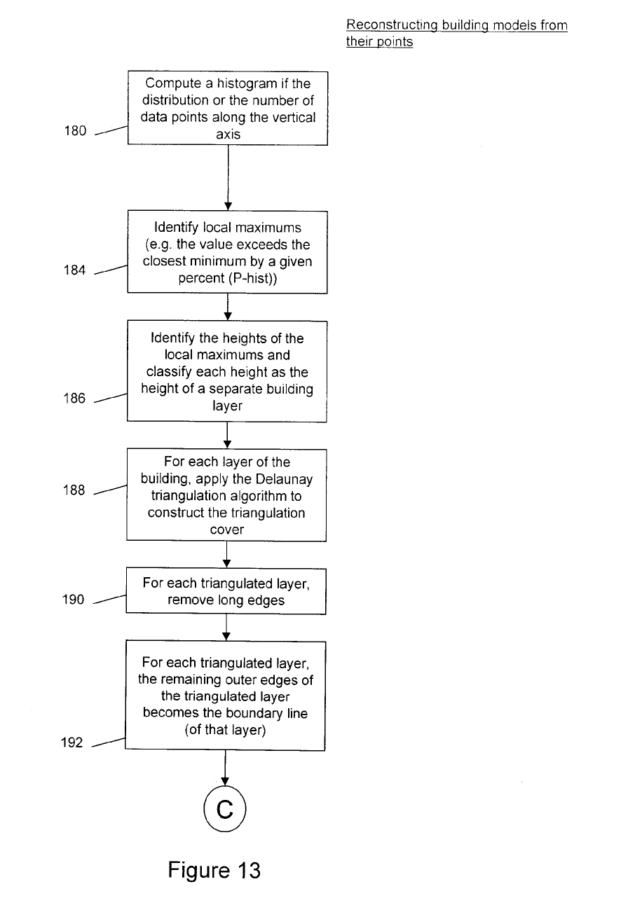

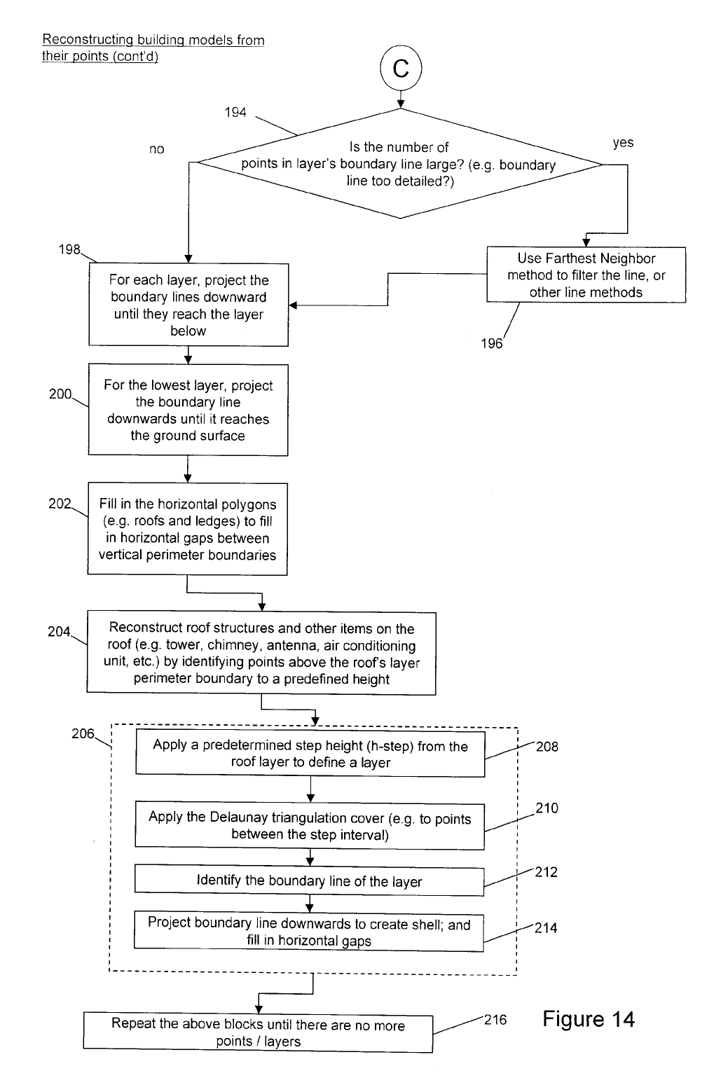

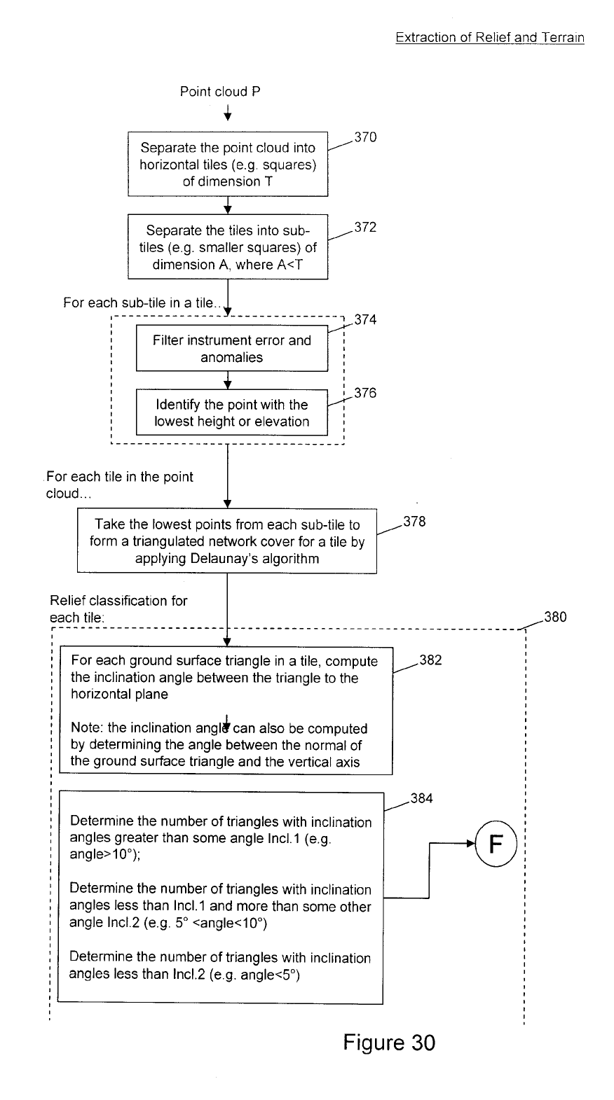

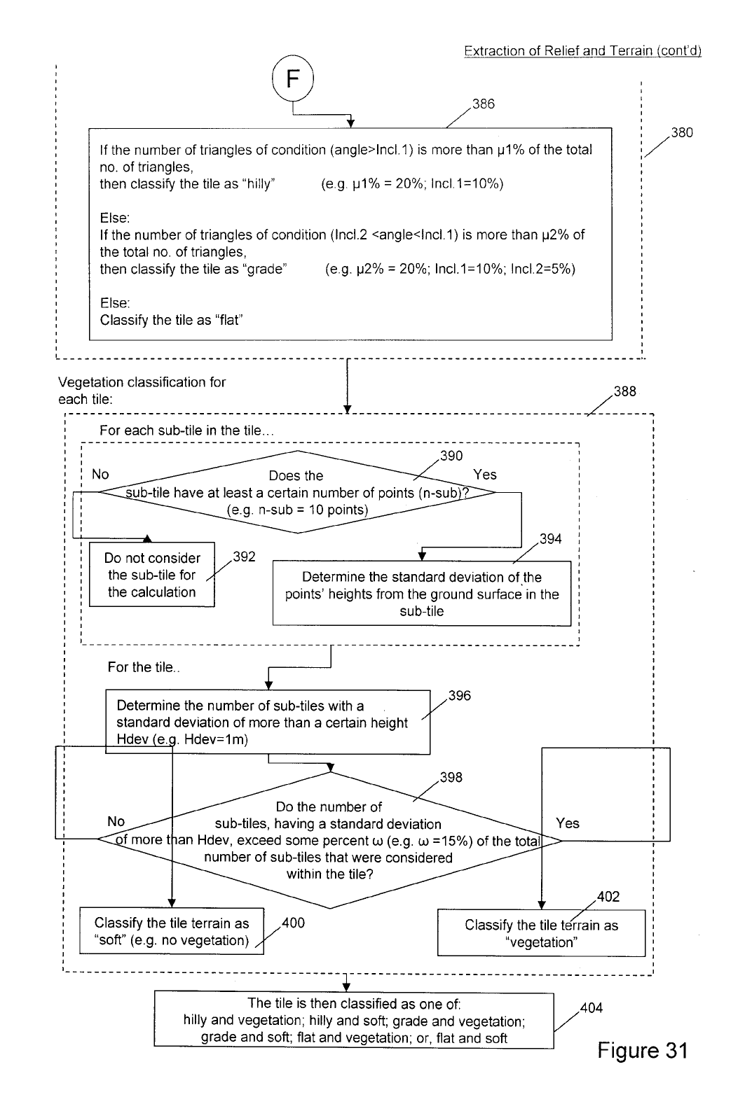

At block 46, an approximate ground surface is extracted from the point cloud P. Based on the approximate ground surface, the relief and terrain classification of the ground is determined (block 47). This is discussed in further detail with respect to module 44 (e.g. FIGS. 30 and 31). At block 48, the relief and terrain classification is used to determine the value of certain parameters for extracting a more accurate ground surface from the point cloud. At block 49, a more accurate ground surface is extracted. This is discussed in further detail with respect to module 32 (e.g. FIGS. 4, 5, 6 and 7). At block 50, ground surface points and points near the ground surface are classified as “base points”. Therefore, the remaining unclassified points within the point cloud P has been reduced and allows for more efficient data processing. At block 51, from the data points that are not classified as “base points”, points representing a building are extracted. This is discussed in further detail with respect to module 34 (e.g. FIG. 8). At this stage, the building points may include some vegetation points, especially where vegetation overlaps or is adjacent to a building. Therefore, at block 53, vegetation points are separated from the building points to further ensure that the building points accurately represent one or more buildings. This is discussed in further detail with respect to module 40 (e.g. FIG. 12). The remaining points more accurately represent a building and, at block 54, are used to reconstruct a building model in layers. This is discussed in further detail with respect to module 42 (e.g. FIGS. 13 and 14).

Upon extracting the ground surface, buildings, and vegetation from the point cloud P, it can be appreciated that the remaining unclassified points have been reduced. Thus, extracting other features becomes easier and more efficient.

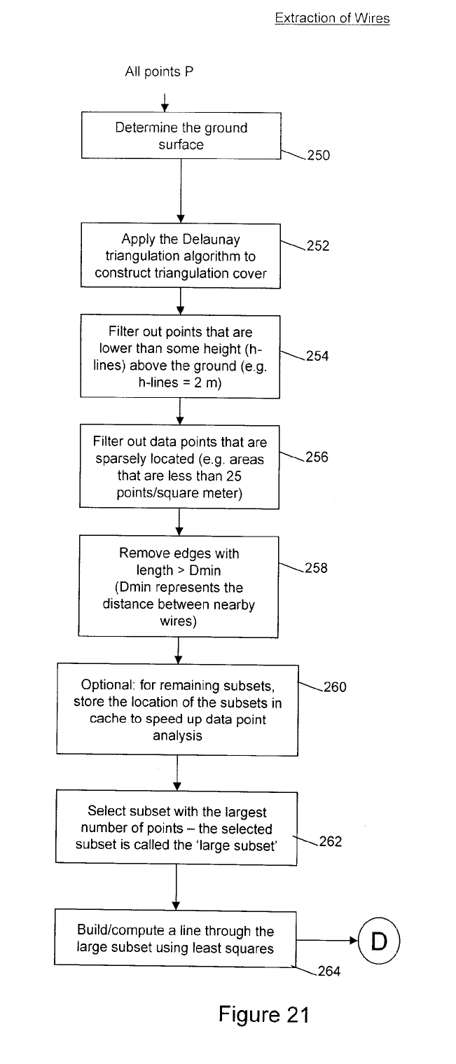

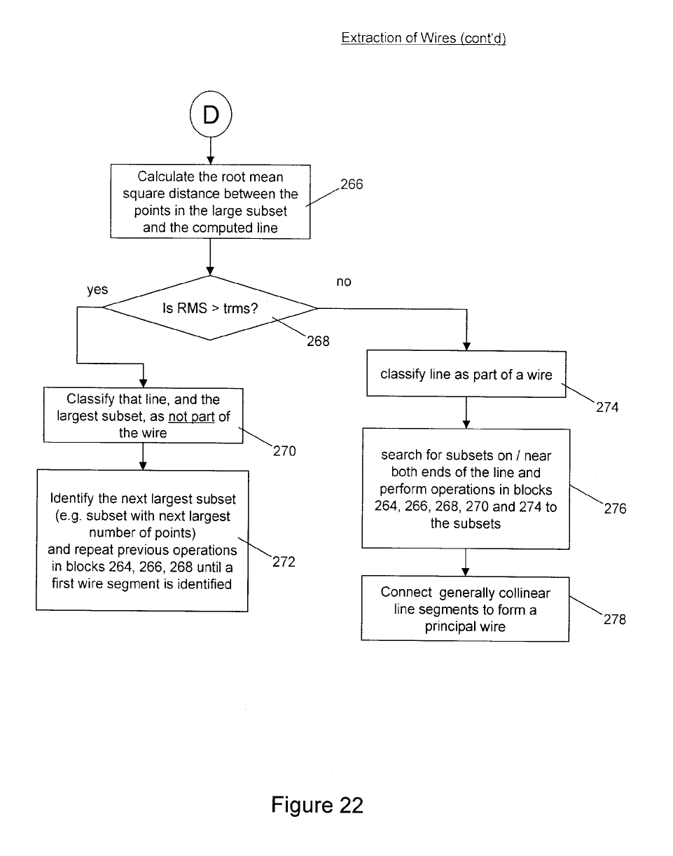

Continuing with FIG. 3, at block 55, from the remaining unclassified points, a segment of a principal wire is extracted. This is discussed in further detail with respect to module 36 (e.g. FIGS. 21 and 22). At block 56, if it is determined that there is no noise surrounding the segment of the wire, at block 58, the other segments of the principal wire are extracted by looking for subsets (e.g. groups of networked points) near the end of the wire segment. After identifying the principal wire, the surrounding wires are located.

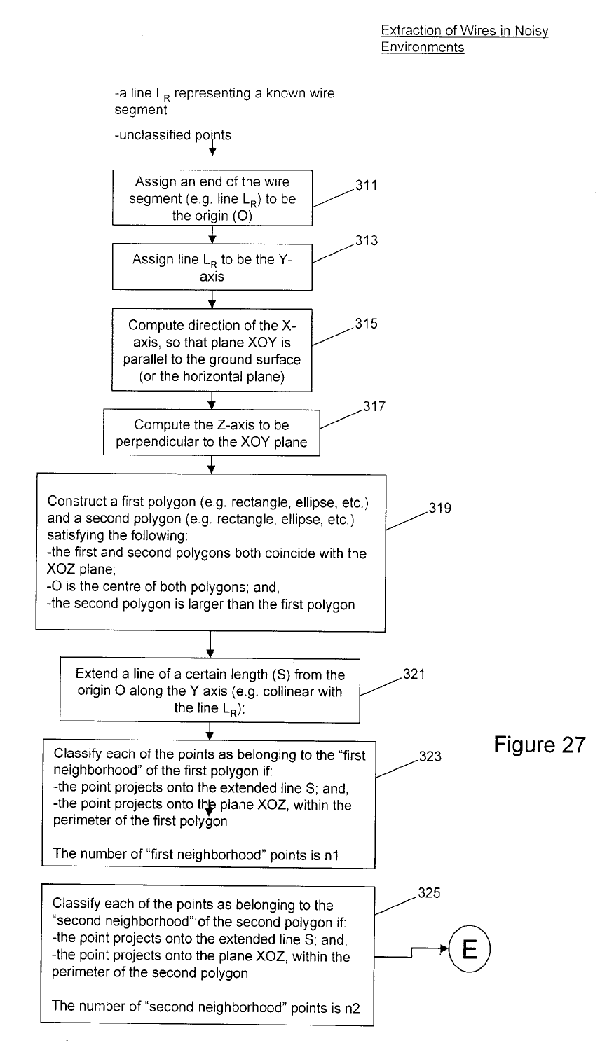

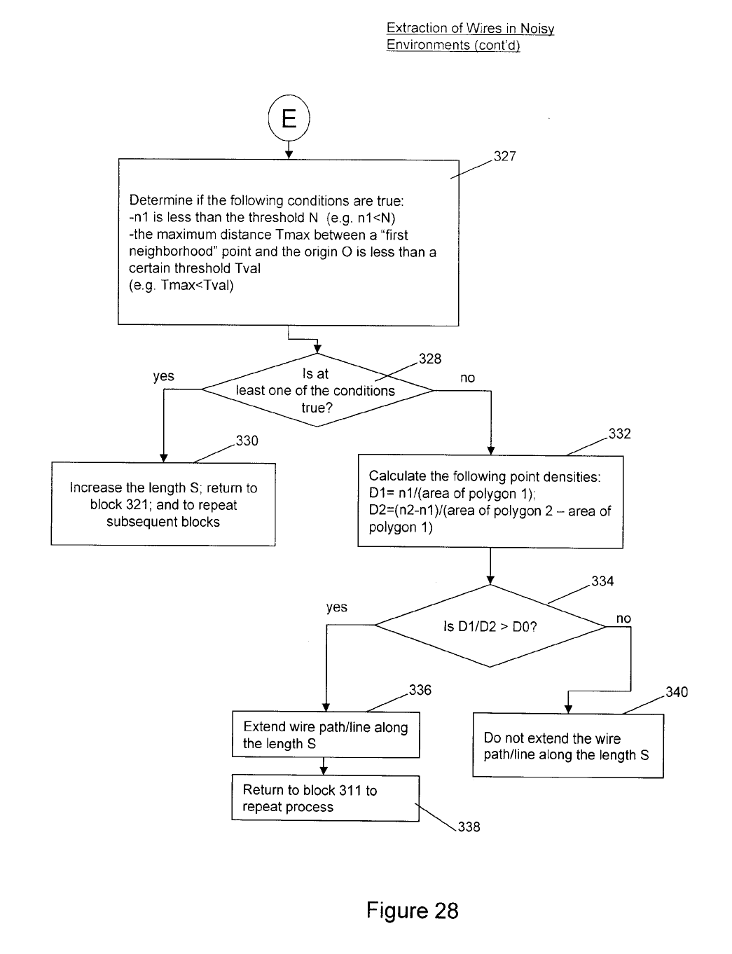

However, if, from block 56, it is determined that there is noise surrounding the segment of the principal wire, then a first and a second polygon are used to extract an extension of the known wire segment. This is discussed in further detail with respect to module 38 (e.g. FIGS. 27 and 28). Similarly, once the principal wire has been extracted, the surrounding wires are extracted at block 59. It can be appreciated that the method of module 38 may also be applied to extract the surrounding wires from a noisy environment, e.g. by using a first and second polygon.

The flow diagram of FIG. 3 is an example and it can be appreciated that the order of the blocks in the flow diagram may vary and may be modified. It can also be appreciated that some of the blocks may be even deleted. For example, many of the blocks may be carried out alone, or in combination with other blocks. Details regarding each of the extraction approaches are discussed further below.

A list of parameters as well as a brief explanation is provided for each module. Some of the parameters may be calculated, obtained from a database, or may be manually inputted. The parameters can be considered as inputs, intermediary inputs, or outputs of the systems and method described herein. The list of parameters is non-limiting and there may be additional parameters used in the different extraction systems and methods. Further detail regarding the parameters and their use are provided below, with respect to each module.

| | |
|---|---|
| P | set of data points (e.g. point cloud) |

Extracting the ground surface (e.g module 32)

| | |
|---|---|
| Max B | maximum building size in the horizontal plane |
| T | tile size |
| R | maximum horizontal distance allowed between a point |
| | and a ground point |
| R-points | set of points within a distance R from their respective |
| | closest ground point |
| Max H | threshold height above the ground surface, where points |
| | above this height are not extracted as ground points |
| Min H | threshold height above the ground surface, where points |
| | below this height are extracted as ground points |
| A1 | angle between (i) the line connecting a point to the |
| | closest ground point; and (ii) the current ground surface |
| A2 | angle between (i) the line connecting a point to the |
| | closest ground point; and (ii) the horizontal plane |
| Max α | Maximum angle threshold between (i) the line connecting |
| | a point to the closest ground point; and (ii) the current |
| | ground surface or the horizontal plane |

Extracting a building (e.g module 34)

| | |
|---|---|
| base points | set of ground surface points and points near the ground |
| | surface |
| h-base | threshold height above the ground surface, where points |
| | under the threshold height form part of the base points |

Reconstructing a building model (e.g. module 42)

| | |
|---|---|
| P-hist | threshold percent that a local maximum on a histogram |
| | must exceed the closest minimum |
| h-step | step height at which layers for structures on the roof are |
| | constructed |

Extracting wires (e.g. module 36)

| | |
|---|---|
| h-lines | minimum height that the wires are expected to be |
| | located at |
| Dmin | expected distance between nearby wires |
| RMS | Root-mean-square distance between a number of points |
| | and a line |
| trms | maximum RMS threshold value that the calculated RMS |
| | can have in order for the points and the line to be classi- |
| | fied as part of a wire |

Extracting wires in a noisy environment (e.g. module 38)

| | |
|---|---|
| L_{R} | line segment classified as a wire |
| S | length of proposed wire extension |
| first | polygon coinciding with XOZ plane and encircling the |
| polygon | origin O |
| second | polygon coinciding with XOZ plane and encircling the |
| polygon | origin O; also larger than the first polygon with a |
| | perimeter that does not overlap the first polygon |
| n1 | number of points counted within the neighbourhood of |
| | the first polygon and the proposed wire extension |
| n2 | number of points counted within the neighbourhood of |
| | the second polygon and the proposed wire extension |
| N | minimum number of points that n1 must have in order |
| | to validate data |
| Tmax | maximum distance measured between one of the “n1” |
| | points and the origin O |
| Tval | minimum distance required between the farthest “n1” |
| | point and the origin O to validate the data |
| D1 | density of points within the neighbourhood of the first |
| | polygon |
| D2 | density of points within the neighbourhood of the second |
| | polygon |
| D0 | minimum density ratio of D1/D2 required for the |
| | proposed wire extension to be extended for length S |

Extracting relief and terrain (e.g. module 44)

| | |
|---|---|
| T | dimension of a tile in the point cloud P |
| A | dimension of a sub-tile within the tile T |
| Incl. 1 | threshold inclination angle between a ground surface |
| | triangle to the horizontal plane |
| Incl. 2 | threshold inclination angle between a ground surface |
| | triangle to the horizontal plane, where Incl. 2 < Incl. 1 |
| μ1 | minimum percentage of triangles in a tile, having |
| | inclination angles greater than Incl. 1, required to |
| | classify the tile as hilly |
| μ2 | minimum percentage of triangles in a tile, having |
| | inclination angles greater than Incl. 2 and less than |
| | Incl. 1, required to classify the tile as grade |
| n-sub | minimum number of points in a sub-tile required for |
| | the sub-tile to be considered valid for consideration |
| H-dev | minimum standard deviation of the heights of points, |
| | above the ground surface, in a sub-tile required to |
| | consider the sub-tile as “vegetation” |
| ω | minimum percentage of sub-tiles in a tile, having a |
| | standard deviation of at least H-dev, required to |
| | classify the tile as “vegetation” |

Module 32 comprises a number of computer executable instructions for extracting the ground surface feature from a set of data points. These computer executable instructions are described in more detail in FIGS. 4, 5 and 6. In general terms, the method is based on the geometric analysis of the signal returned from the ground and from features and objects above the ground. A characteristic of a typical ground surface point is that it usually subtends a small angle of elevation relative to other nearby known ground points. Using this principle, an iterative process may be applied to extract the ground points. Initially, the lowest points, as indicated by their spatial coordinates, are selected and considered as ground-points. The initial ground points may be determined by sectioning or dividing a given area of points into tiles (e.g. squares) of a certain size, and then selecting the point with the lowest height (e.g. elevation) from each tile. The ground points may then be triangulated and a 3D triangulation network is built. Then, points that satisfy elevation angle criteria are iteratively added to the selected subset of ground points in the triangulated network. The iterative process stops when no more points can be added to the network of triangulated ground points. The selected ground points may then be statistically filtered to smooth small instrumental errors and data noise that may be natural or technological.

Turning to FIG. 4, example computer executable instructions are provided for extracting the ground surface from a set of data having spatial coordinates (herein called the point cloud P). It can be appreciated that distinguishing a set of points as “ground surface” may be useful to more quickly identify objects above the ground surface.

Points in the point cloud P may be considered in this method. At block 62, the maximum building size (Max B) in the horizontal plane is retrieved (for example, through calculation or from a database). The value of Max B may also be provided from a user. For example, Max B may represent the maximum length or width of a building. At block 64, a tile size (T) is determined, where T is larger than Max B. At block 66, a grid comprising square tiles having a dimension of T×T is laid over the point cloud P. In this way, the points are grouped or are separated into tiles. The data points are therefore subdivided into sets falling within the boundaries of each tile. The dimensions of each tile should preferably be larger than the largest building foot print to guarantee the presence of one or more ground points in each tile. In other words T should be greater than Max B. By applying such a condition, for example, the risk of mistakenly characterizing a data point on a large warehouse roof as a ground point is reduced.

Continuing with FIG. 4, at block 68, for each set of points within the tile, the points in the tile that are considered to be the result of instrument error or anomalous, are filtered away. In other words large errors, such as gross errors caused by equipment collection malfunction, and recognised by being a multiple number of standard deviations from the mean should be removed. Natural anomalies such as a point coincidentally measured at the bottom of a well or crevasse could also cause such deviations and should be removed. At block 70, for each tile, the data point with the lowest height or elevation is identified from the spatial coordinates of the points. At this stage, if, for example, there is a grid of forty tiles, then there should be forty data points, each being considered the lowest point in their respective tile.

At block 72, using the lowest point of each tile, these lowest points are used to form a triangulated surface cover using, for example, a Delaunay triangulation algorithm. The group of points with the lowest elevation form the initial set of ground points. It can be appreciated that in the triangulated surface, each of the lowest data points forms a vertex of one or more triangles.

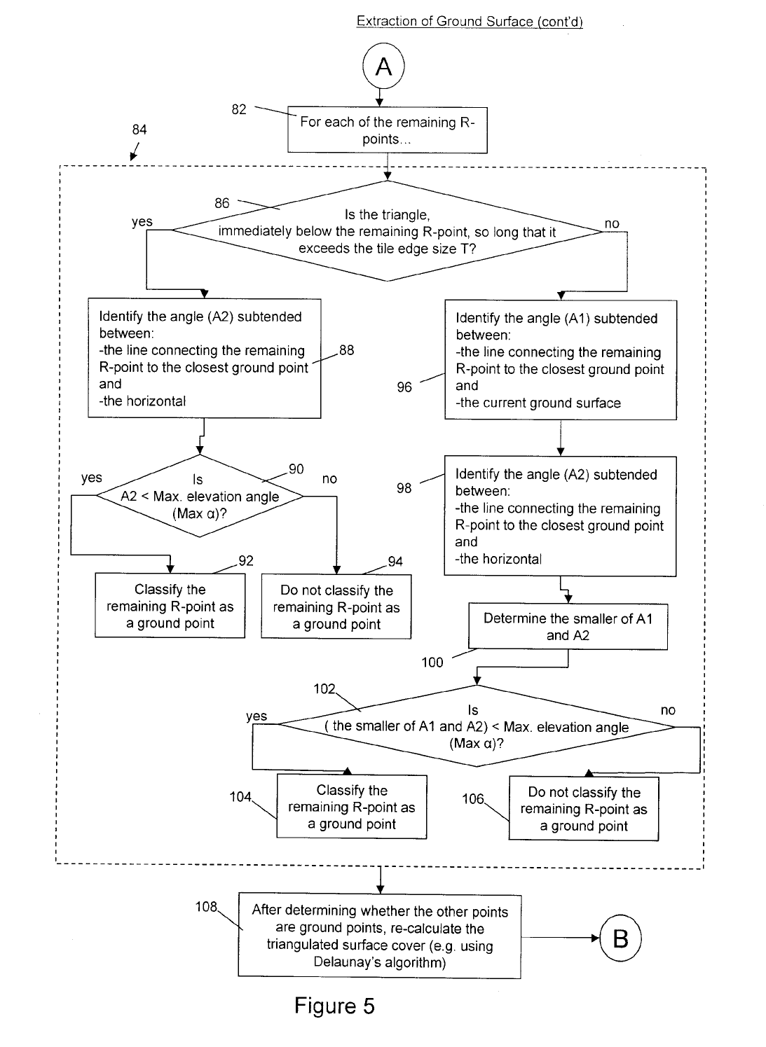

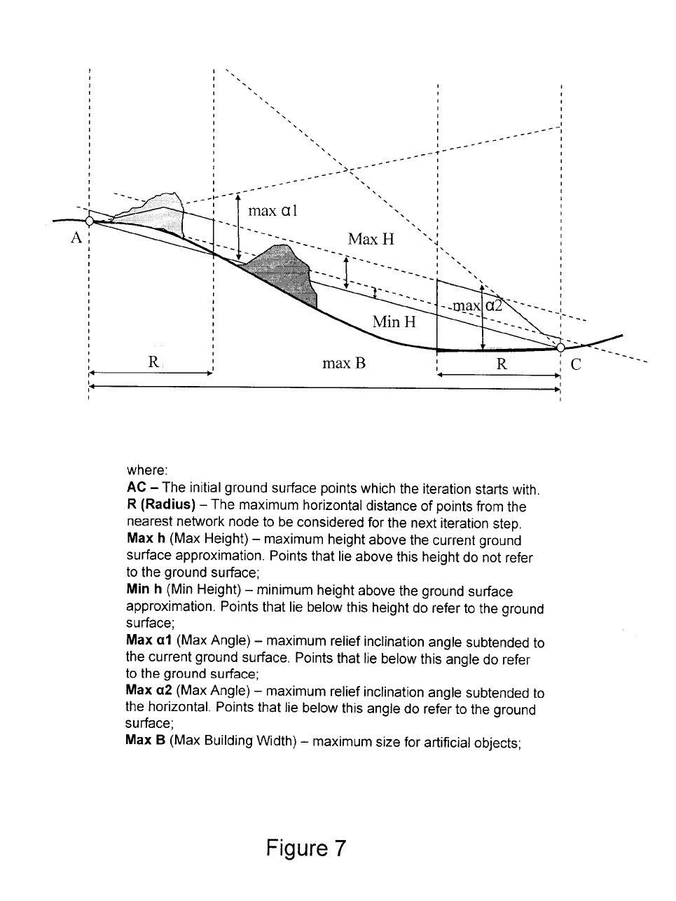

At block 74, it is then determined whether the remaining points in each tile should be classified as ground points. It can be understood that from block 74 onwards, the operations become iterative. In the first iteration, the remaining points are those points that are not the lowest points within their respective tiles. In particular, at block 76, points that are within a certain horizontal distance (R) from any one of the current ground points are identified; these identified points may herein be referred to as R-points. An example of the measurement R is shown in FIG. 7, which extend relative to two ground points, point A and point C. Referring back to FIG. 4, at block 78, from the set of R-points, the computing device 20 removes points that are above the triangulated surface cover by a certain height (Max H). In other words, if an R-point has an elevation above the triangulated surface cover by at least some height Max H, it is not considered a ground point in the current iteration. At block 80, from the set of R-points, the computing device 20 classifies any R-point as a ground point if it has an elevation no higher than a certain height (Min H) above the triangulated surface cover. In other words, if the R-point is close enough to the ground, below the threshold height Min H, then the R-point is considered as a ground point. Referring briefly to FIG. 7, example measurements of the parameters Min H and Max H are shown relative to a ground surface approximation, whereby the ground surface is formed by the line connecting point A and point C. As indicated by circle A, the method of FIG. 4 continues to FIG. 5.

Continuing with FIG. 5, at block 82, the computing device 20 carries out a number of operations in block 84 for each of the remaining R-points (e.g. R-points that do not exceed the elevation Max H, and are not below the elevation Min H). In particular, at block 86, it is determined whether the triangle, that is immediately below the R point, is so long that its length exceeds the tile size edge T. If not, at block 96, the angle A1 is identified, whereby angle A1 is defined by or is subtended between (i) the line connecting the remaining R-point to the closest ground point, and (ii) the current ground surface (e.g. the current triangulated surface cover). At block 98, the angle A2 is also identified, whereby angle A2 is defined by or is subtended between (i) the line connecting the remaining R-point to the closest ground point, and (ii) the horizontal. At block 100, the computing device 20 determines which of A1 and A2 is smaller. Then, at block 102, it is determined whether the smaller of A1 and A2 is less than the maximum elevation angle (Max α). If so, at block 104, the remaining R-point is classified as a ground point. If the smaller angle of A1 and A2 is larger than Max α, then the remaining R-point is not classified as a ground point.

The basis of the above analysis is that if a point is at a steep angle from the known ground surface, and from the horizontal, then it is likely that the point may not be a ground point.

If, at block 86, the distance between the remaining R-point and closest ground point is longer than the tile size T, then at block 88, the angle A2 is identified. In other words, the angle A1 is not used since, if the line connecting the remaining R-point and the closest ground point is long, the angle A1 may likely not accurately approximate the ground surface. At block 90, it is determined whether or not the angle A2 is less than the maximum elevation angle (Max α). If so, then the remaining R-point is classified as a ground point in block 92. If not, the R-point is not classified as a ground point in block 94. As discussed above, the blocks within block 84 are applied to each of the remaining R-points to identify which of these are to be classified as ground points.

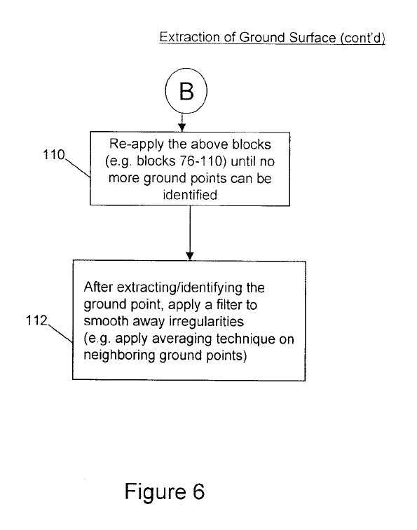

Continuing with FIG. 5, at block 108, after determining whether the other points are ground points, the triangulated surface cover (e.g. ground surface) is re-calculated taking into account the newly classified ground points. As indicated by circle B, the method of FIG. 5 continues to FIG. 6.

In FIG. 6, at block 110, the operations of determining whether other points are ground points is repeated in an iterative process. In particular, blocks 74 to 110 are repeated. The process stops re-iterating itself when no more ground points can be identified. When no more ground points can be identified, at block 112, a filter may be applied to smooth away irregularities. In one example, the filter may include an averaging technique applied to neighbouring ground points. An example of an averaging technique is to use a weighted average of the heights of surrounding points, which is weighted inversely with the square of their distance away. It is known that inverse square weighting attributes closer points to have a larger influence and more distant points to have a very small influence.

It can be appreciated that the above uses pre-defined criteria threshold values namely: tile edge size (T), maximum building width (Max B), maximum horizontal distance for each iteration (R); maximum elevation above the network (Max H), minimum elevation above the network (Min H) and maximum elevation angle (Max α). These threshold values can be changed to fine tune the efficiency of the process and the accuracy of the resulting ground surface, and how closely it approximates the actual ground surface. An example illustration of these parameters is provided in FIG. 7.

Certain threshold values may result in efficient and accurate results for flat terrain while others may be required to obtain efficient and accurate results for hilly terrain. Similarly heavily treed areas, high density urban areas and agricultural areas and other typical terrain types will require different sets of parameters to achieve high efficiency and accuracy in their resulting ground surface approximations. For example, the maximum angle max α is set to be larger for hilly terrain to accommodate the steeper gradients. The maximum angle max α is set to be smaller (e.g. less than 2°) for flat terrain. The relief and terrain definition module 44, which will be discussed further below, can be used to automatically determine the relief and vegetation classification of a tile (or data set) so that different sets of criteria can be automatically applied in the ground surface extraction module 32.

Upon completion of the ground extraction iteration, the points representing ground are identified in the point cloud and may be excluded from further feature extraction, if desired.

Turning to FIG. 8, example computer executable instructions for extracting one or more buildings from a point cloud P are provided. It can be appreciated that these computer executable instructions may form part of module 34. The method may take into account that the data points which represent a certain building are isolated in 2D or 3D space and are elevated above the ground surface. In general, the method may include: separation of points reflected from the ground surface and points reflected above the ground surface; segmentation of local high-density XY-plane projected groups of points that are above the ground surface; analysis of each group in order to find out if the points within a group belong to an object that represents a building; noise-filtering of building related points (e.g. removal of vegetation points); and reconstruction of a building model out of the point cloud that represents a certain building. Details are described below with respect to FIG. 8.

The set of points within the point cloud P are used as an input. At block 120, points are classified as ground surface points and non-ground surface points. The classification of ground surface points may take place using the instructions or operations discussed with respect to module 32, as well as FIGS. 4, 6 and 6. At block 122, the ground surface points are also classified as “base points”. At block 124, non-ground surface points that are elevated above the ground surface within a threshold height (h-base) are classified as “base points”. In other words, non-ground points that are near the ground surface, within some height h-base, are also considered base points. In one example embodiment, the threshold height h-base may represent the desired minimum building height (e.g. half of a storey) to filter out points that may not belong to a building. Then, for all non-base points in the point cloud P, the Delaunay triangulation algorithm is applied to construct a triangulation cover.

Delaunay triangulation is often used to generate visualizations and connect data points together. It establishes lines connecting each point to its natural neighbors, so that each point forms a vertex of a triangle. The Delaunay triangulation is related to the Voronoi diagram, in the sense that a circle circumscribed about a Delaunay triangle has its center at the vertex of a Voronoi polygon. The Delaunay triangulation algorithm also maximizes the minimum angle of all the angles in the triangles; they tend to avoid skinny triangles. Although the Delaunay triangulation algorithm is referenced throughout this and other methods described herein, it can be appreciated that other triangulation algorithms that allow a point to form a vertex of a triangle are applicable to the principles described herein.

At block 128, all edges that have at least one node (e.g. one point) that is classified as a base point are deleted or removed. In this way, for all objects that are above the ground surface, the grouping of data points representing each of the objects are separated from the ground surface. Thus a number of subsets (e.g. grouping of data points) are created, since they are no longer connected to one another through the layer of base points.

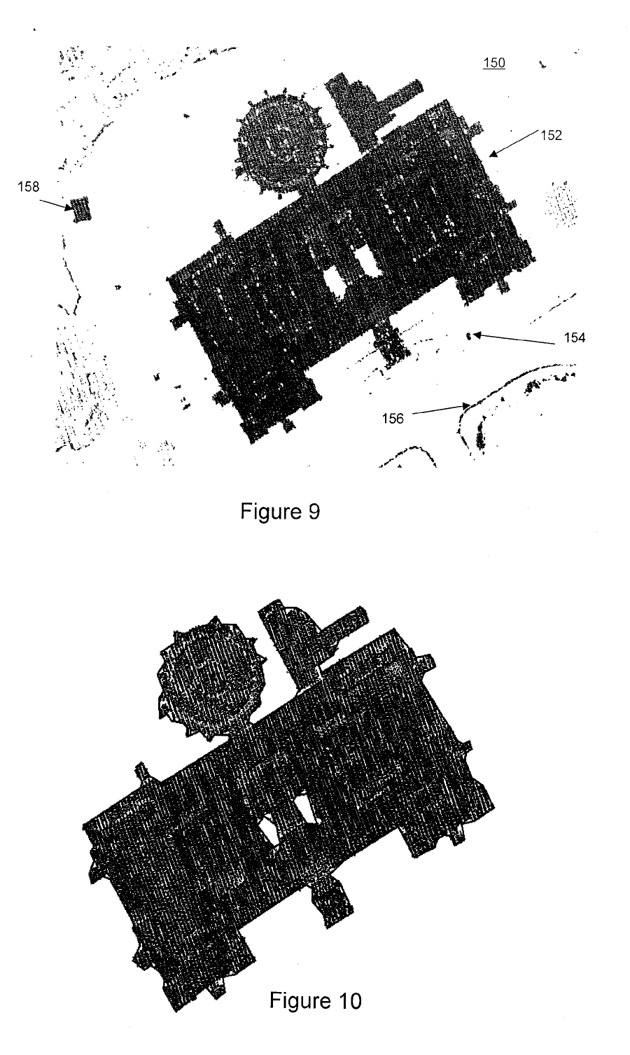

At block 130, subsets having a small area or inappropriate dimension ratios are deleted or removed. For example, turning to FIG. 9, a planar view of a point cloud 150 is provided, illustrating the foot-print of a building 152. Objects 154 and 158 with a small area are removed. Other objects, such as a curb 156, which has a high length-to-width ratio, are also removed. In an example where building roofs are measured, the small area refers to the area of a building as viewed from above. In particular, “small” refers to areas that are smaller than the smallest building area as viewed from above.

At block 132, the computing device 20 removes points that are classified as texture points, which are data points that indicate a surface is a textured surface. It can be appreciated that the textured points may not necessarily be deleted, but rather identified as non-building points. Generally, buildings have smooth surfaces, while natural objects, such as vegetation, have textured surfaces. In this way, the removal of textured points removes vegetation. For example, if the data points were collected using LiDAR, and if a single laser beam was emitted and hit a smooth surface (e.g. brick wall), then a single return beam would reflect back from the smooth surface. However, if a single laser beam was emitted and hit a textured surface (e.g. foliage of a tree), there would be multiple reflections and several return beams (or texture points) would be generated. Therefore, in the example of LiDAR collected data, texture points may be those points that are not mapped to a unique originating beam. Texture information in LiDAR data can be stored in .LAS files. The files store an attribute which indicates the number of returns for each laser measurement. Based on the number of returns, the texture information is obtained.

Continuing with FIG. 8, after removing the textured points, at block 134, the Delaunay triangulation algorithm may be re-applied to reconstruct the triangulation cover and repair holes in the network which had been created by point removal.

It can be appreciated that, at this stage, there may be a large-area subset (e.g. representing the main building) that may be surrounded by smaller area subsets (e.g. representing extensions of the main building). At block 136, if it is determined that the subsets have a “large enough” area, they are connected to the closest or nearest “large enough subset”. In this way, different parts of a building may be connected together. Alternatively, if the smaller-area subsets are “close enough” to the largest subset (e.g. the main building) and they are also “large enough” to be considered a building, then smaller-area subsets are added to the largest subset. It can be appreciated that the values or range of values defining “large enough” and “close enough” may be adjusted to vary the sensitivity of the filtering. Threshold values for defining “close enough” should be selected so that individual buildings (e.g. residential houses) are not mistakenly linked together. This method may also be applicable for extracting buildings of a complex shape, such as with internal clearings or patios. The method may also be used to retain small structural details, such as pipes and antennas.

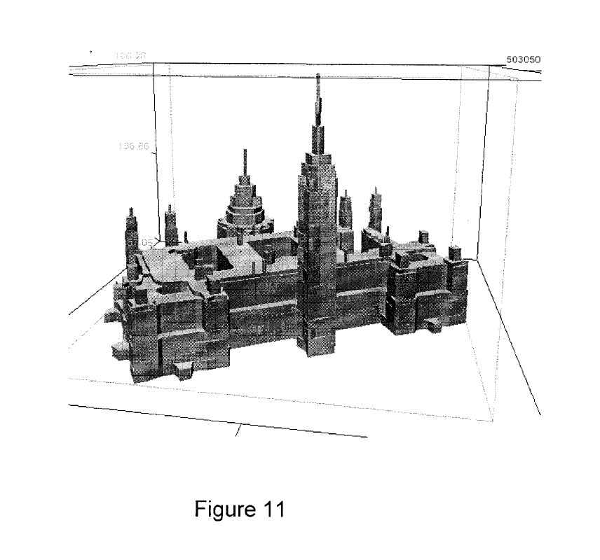

At block 138, subsets that are considered to be not “large enough” are removed from the set of points for under consideration to identify a building. At this stage, the subset of points define a building. Optionally, at block 140, an edge-detection algorithm may be applied to the subset of points to outline the building. For example, FIG. 10 shows the subset of points belonging to the building only, with other points removed. At block 142, a known surface reconstruction algorithm may be used to build a shell of the building. The reconstructed surfaces of the building is used to illustrate the building in a 3D visualization, which can be displayed on the display device 18. An example of a reconstructed 3D visualization of a building is shown in FIG. 11.

In another aspect of extracting features from a point cloud, when determining the extent of a building, vegetation on or near a building may obscure the building itself, and give a false visualization. Turning to FIG. 12, example computer executable instructions are provided for separating vegetation from buildings, which is done prior to edge detection and rendering. Such instructions may form part of module 40. In general, a method is provided which separates the points reflected from the buildings and the points reflected from nearby or adjacent vegetation. It is assumed that the ground points have already been extracted, for example, using the method described with respect to FIGS. 4, 5 and 6. The method described in FIG. 12 is based on the analysis of the structure of the triangulation network, which is built out of the points reflected from buildings as well as vegetation that is adjacent to or nearby the buildings. Trees can be recognized by the large number of steep (e.g. vertical-like) edges they produce in such a triangulation network. In contrast, the roofs of the buildings may be characterized by a small quantity of such steep edges. In general, to separate building and vegetation points, steep edges are removed from the triangulation network. The removal of steep edges can lead to the creation of single or lone points in the vegetation areas, which can be subsequently removed. As a result, part of the triangulation network, which also includes vegetation data points, will be decomposed to a number of smaller parts and single points. These smaller areas, e.g. representing vegetation, can be removed. The remaining areas, which are more connected, may define the buildings.

In particular, in FIG. 12, at block 170, a ground detection algorithm is applied to separate ground surface points from non-ground surface points. At block 172, the Delaunay triangulation algorithm is applied to construct a triangulation cover. At block 174, all long edges that have a steep angle to the horizontal plane are removed. In this way, the groups of points belonging to vegetation are separated. At block 176, the small area subsets (e.g. representing vegetation) are removed. At this stage, the remaining points are considered to be points of a building. At block 178, the Delaunay triangulation algorithm may be re-applied to the remaining points in the triangulation network to reconstruct the triangulation cover.

It may appreciated that the example instructions of FIG. 12 may be used in combination with the building extraction method described with respect to FIG. 8. In one example embodiment, between blocks 128 and 130, or between blocks 130 and 132, or between blocks 132 and 134, the method of separating vegetation from a building, as described with respect to FIG. 12, may be inserted. Any combination that allows for both the building to be extracted and for the vegetation to be separated from the building is applicable to the principles described herein.

In another module, the building reconstruction module 42 includes computer executable instructions to reconstruct the structure or shell of a building from the data points. In particular, FIGS. 13 and 14 show example computer executable instructions for reconstructing building models. The method may be based on piecewise stationary modeling principles. The building may be split or divided into horizontal layers (or floors), and it may be assumed that the horizontal area of the building remains the same within each layer. To identify the different layers of the building, a frequency histogram of the distribution of the data points along the vertical axis for each building is computed. The concentration of points projected on the histogram's axis identifies any flat horizontal parts of the buildings, such as the roofs or ledges. The heights of the histogram's peaks represent a high concentration of points, which can be used to define the boundaries between the layers. Perimeters of each layer of the building are computed, and from each layer perimeter, walls are projected downwards. This constructs a model consisting of vertical and horizontal polygons which represents the building shell. Based on the building shell, the main spatial and physical parameters of the building, such as linear dimensions and volume, can be obtained.

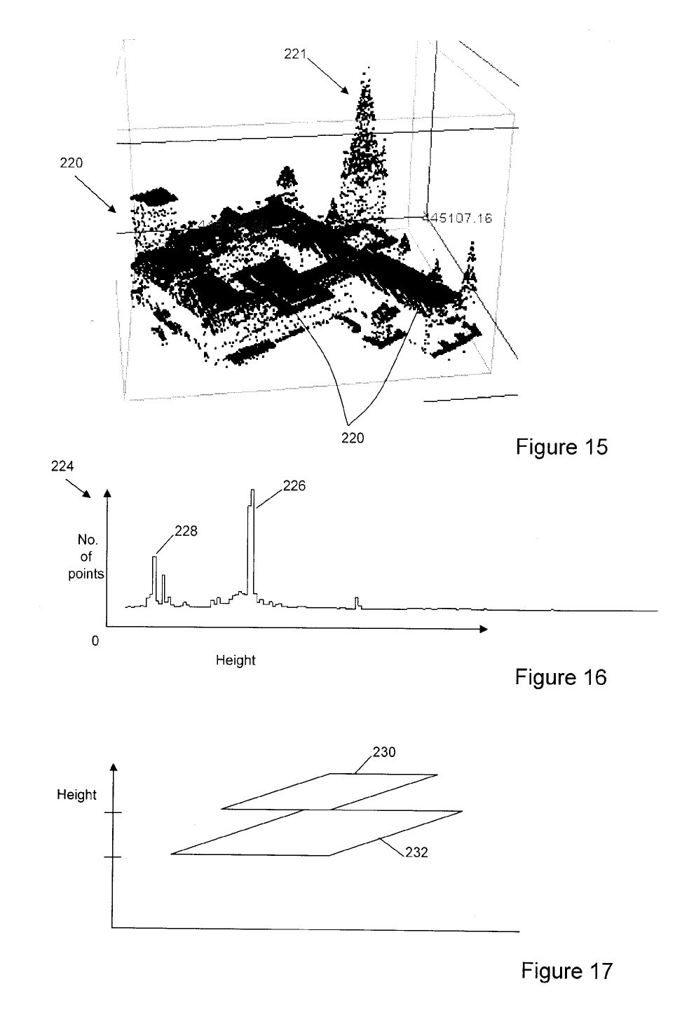

Turning to FIG. 13, it can be appreciated that the inputted data points are considered to be already classified as building points of a certain building. For example, a point cloud 220 of building points is shown in FIG. 15. It can be appreciated that the roof top 222 has a higher concentration of points (e.g. denser or darker point cloud) since the data points were collected from overhead, for example, in an airplane. At block 180, a histogram of the distribution or the number of data points is computed along the vertical or elevation axis. An example of such a histogram 224 is shown in FIG. 16. The peaks 226, 228 of the histogram represent a high density of data points at a given height, which indicates the height of the flat parts (e.g. roofs, ledges) of a building. The histogram may also represent at what heights the horizontal or planar cross-sectional area of the building is changing.

At block 184, the local maximums of the histogram are identified. For example, a value on the histogram may be considered a local maximum if its value (e.g. number of points) exceeds the closest minimum by a given percent (P-hist). Adjusting the value of the given percent P-hist may adjust the sensitivity and level of detail of the building's reconstruction. For example, a smaller value for P-hist would mean that the building reconstruction may be more detailed, while a larger value for P-hist would mean that the building reconstruction is less detailed. At block 186, the heights of the local maximums are identified. Further, each height of a local maximum is classified as the height of a separate building layer. In this way, the heights of the different building layers are identified.

At block 188, for each layer of the building, the Delaunay triangulation algorithm is applied to construct a triangulation cover, for example, using the horizontal coordinates XY. At block 190, for each triangulated layer, the long edges are removed. In one example embodiment, a long edge is one that would be longer than the known length of an internal courtyard of a building, such that the long edge may extend across and cover such a courtyard. The remaining outer edges of the triangulated network are used to build the layer perimeter boundary lines. In particular, at block 192, for each triangulated later, the outer edges of the triangulated layer become the boundary line of that layer. As an example, FIG. 17 shows two triangulated layers 230 and 232 having different heights and a different area. In the example, the layers 230 and 232 have rectangular boundary lines. As indicated by circle C, the method of FIG. 13 continues to FIG. 14.

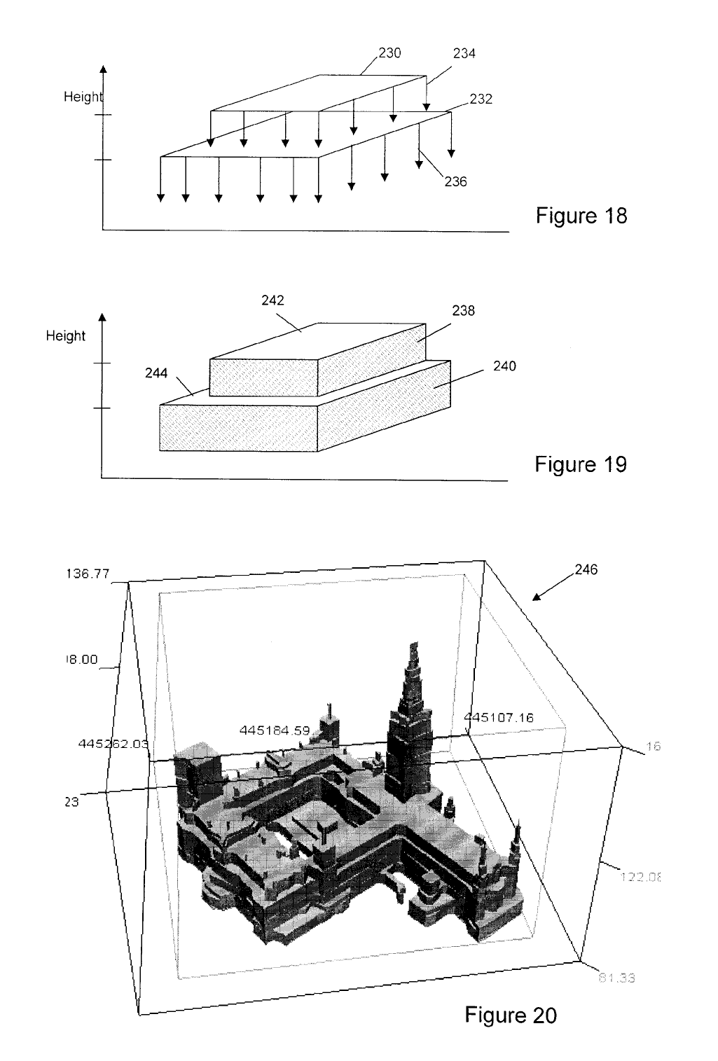

In FIG. 14, at block 194, the computing device 20 determines whether or not the number of points in the boundary line is large. In other words, it is determined whether or not the boundary line is too detailed. If so, at block 196, a farthest neighbour method may be used to filter or smooth the line. An example of the farthest neighbour method is the Douglas Peuker line filtering method, which is known as an algorithm for generalizing line features while preserving the overall shape of the original line. Alternatively, other line filtering or smoothing methods may be used. From block 196, the method may proceed to block 198. It can be appreciated that, if the line was not too detailed, then block 194 may proceed to block 198. At block 198, for each layer, the boundary lines are projected downwards until they reach the layer below. At block 200, for the lowest layer, its boundary line is projected downwards until it reaches the ground surface. For example, in FIG. 18, the boundary lines of layer 230 is projected downwards (234) until it reaches layer 232 below. It can be appreciated that projections may be vertical, substantially vertical, or at angles to the horizontal plane. The boundary lines of layer 236 (e.g. the lowest layer) is projected downwards until it reaches the ground. As can be seen in FIG. 19, the projections represent the walls 238 and 240 of the building.

Returning back to FIG. 14, at block 202, the horizontal polygons (e.g. roofs, ledges) are filled in. In other words, the horizontal gaps between the walls are filled in. For example, as shown in FIG. 19, the horizontal surfaces 242 and 244 may be filled in to represent the roofs and ledges of a building.

Continuing with FIG. 14, at block 204, the computing device 20 reconstructs roof structures and other items on the roof (e.g. tower, chimney, antenna, air unit, etc.) by identifying points above the roof layer's perimeter boundary. In other words, points that are above the area of the roof are identified. For example, turning briefly to FIG. 15, the group of points 221 are above the roof layer.

A set of operations 206 are applied to construct layers above the roof. In particular, at block 208, a predetermined step height (h-step) is added to the roof layer, thereby defining the height of a new layer above the roof. It can be appreciated that using a smaller value for the parameter h-step may allow for higher resolution or more detail of the roof structures. An example value for h-step is 5 meters, which would be suitable to construct a rough block of a building's steeple. An example value of h-step=0.5 meters would construct a more detailed building steeple. At block 210, the Delaunay triangulation cover is applied to the points in the layer, that is, all points which are were found to be between the step intervals. The boundary line (e.g. outer edge) of the layer is then identified (block 212). At block 214, the boundary line is projected downwards to the layer below to create a shell. Further, the horizontal gaps may also be filled in. It can be appreciated that in the first iteration, the boundary line of the roof structure is projected downwards to the roof layer. At block 216, the set of operations 206 are repeated for the points above the layer. In other words, a higher layer is formed at a predetermined step height above the previous layer (block 208), before proceeding to blocks 210, 212 and 214 again. The set of operations 206 reiterate themselves until there are no more points that are located above the roof, so that no more layers can be formed (block 216).

It can be seen that the above operations may be used to reconstruct a building structure from data points. For example, in FIG. 20, a building structure 246, including steeples, posts, ledges, towers, etc., may be computed using the above described method and displayed in detail. It can also be appreciated the method described with respect to FIGS. 12, 13 and 14 may be used in combination with the building extraction method, described with respect to FIG. 8. In particular, the building reconstruction method may be used in combination with or in place of blocks 140 and 142 of FIG. 8.

In another aspect, module 36 may include computer executable instructions for extracting wires (e.g. power lines, cables, pipes, rope, etc.) from a data point cloud P. Power-lines may generally be made of a finite number of wires, which can go in parallel, in various directions, or approach their target objects (e.g. poles, transformer stations, etc.). Reconstruction of the whole power-line may be more feasible after reconstructing each wire separately. The term “wires” as used herein may refer to various types of long and thin structures.

In general, the reconstruction of wires begins with separating the points from the ground surface, for example, using the method described with respect to FIGS. 4, 5 and 6. It may also be assumed that the point cloud contains points that belong to a wire. Segmentation or identification of points that belong to a single wire is an important part of the described method. First, a principle wire is identified based on the density of points. The segments of the principal wire are identified along the length, and then the segments are connected to form the length of the principal wire. After identifying the principal wire, ancillary wires surrounding the principal wire are identified by examining the projection of points on to a plane perpendicular to a plane of the principal wire. A higher density of projected points on to the plane indicates the presence of surrounding wires. Segments of the surrounding wires are then identified and connected together in a similar manner to the construction of the principal wire.

Turning to FIG. 21, example computer executable instructions for extracting wires from a point cloud are provided. At block 250, using the set of data points in the point cloud P, the ground surface is determined. At block 252, the Delaunay triangulation algorithm is applied to the point cloud to construct a triangulation cover. At block 254, points that are lower than some height (h-lines) above the ground surface are removed or filtered out. In this way, points that are near the ground are removed, since it may be assumed that the wires must be of a certain height. For example, the parameter h-lines may be 2 meters. At block 256, data points that are sparsely located are also removed or filtered out. It is assumed that wires have a certain point density. In one example, the point density of wires should be at least 25 points per square meter.

At block 258, edges in the triangulated network with length greater than a predetermine length (Dmin) are removed or filtered away. The parameter Dmin represents the distance between nearby (e.g. parallel-running) wires. The parameter Dmin is determined using a known standard or is measured. For example, for power lines, it may be known that parallel-running wires must be at least some distance apart from one another. It can be appreciated that removing edges longer than Dmin ensures that separate wires are not mistakenly represented as a single thick wire. After removing the long edges, at this stage, there are multiple subsets (or groupings) of triangulated points.

At block 260, for the purpose of speeding up data point analysis, the locations of the subsets may be stored in memory. In this way, the grouping of points, as identified in part by their location, may be quickly retrieved for analysis.

Continuing with FIG. 21, at block 262, the computing device 20 identifies and selects the subset with the largest number of points. This selected subset may be herein referred to as the “large subset”. The largest subset is used as a starting data set, since it may likely be part of a wire. At block 264, a line passing through the largest subset is computed using a least squares calculation. It can be appreciated that other line fitting algorithms may be used. As indicated by circle D, the method of FIG. 21 continues to FIG. 22.

Continuing with FIG. 22, at block 266, the root mean square (RMS) distance between the points in the subset and the computed line of block 264 is determined. The RMS distance is used to determine the concentration of points or location of points relative to the line. A large RMS distance may indicate that the points in the subset are spread out and do not closely represent a line (or a wire). A small RMS distance may indicate that the points in the subsets are closer together and more closely represent a line (or a wire). At block 268, it is determined whether or not the RMS distance is greater than a threshold (trms). The value for the threshold trms may be determined by a user, empirical data, or through some other methods. If the RMS distance of the subset is greater than the value of the threshold trms, then the line and its associated subset are classified to be not part of the wire (block 270). At block 272, the computing device 20 then identifies the next largest subset (e.g. the subset with the next largest number of points) and repeats the operations set forth in blocks 264, 266, 268 and optionally blocks 270 and 272, until a subset is identified having a computed line and RMS distance that is less than or equal to the threshold trms.

If, at block 268, the RMS distance of a certain subset is not greater than the threshold trms, then at block 274, the computed line of the certain subset is classified as part of the principal wire. Once the first segment of the principal wire is identified, at block 276, the computing device 20 searches for subsets that are on or near either ends of the line. Subsets that are on or near the end of a line are within an acceptable distance from the end of the wire. Further, the subsets preferably have a length that is oriented the same way as the wire. Once such subsets are identified, the operations set forth in blocks 264, 266, 268, 270 and 274 are applied to classify whether or not these subsets form part of the wire. In this way a number of subsets may be sequentially identified as subsets belonging to or classified as part of a principal wire.

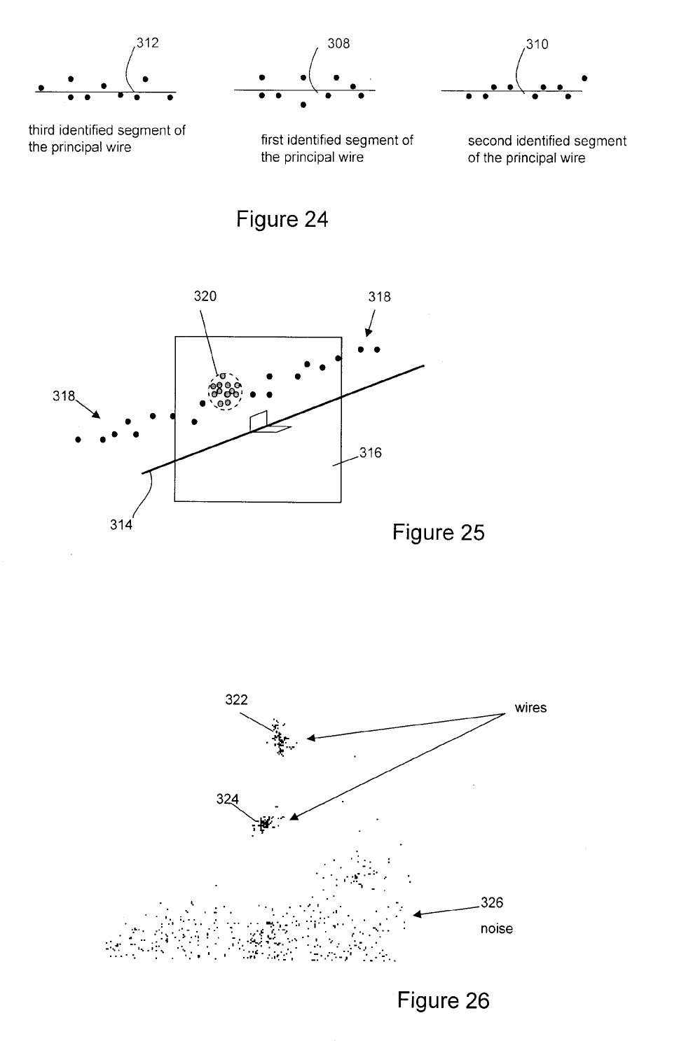

Turning briefly to FIG. 24 an example of different segments of a principal wire is shown. The first classified segment 308 of the principal wire is shown. On one end of the first segment 308, the second classified segment 310 of the principal wire is shown. On the other end, the third segment 312 of the principal wire is shown. It can be appreciated that the segments 308, 310, 312 may be somewhat collinear, since the locations of the subsequent-classified segments were identified relative to the ends of previous-classified segments of the principal wire.

Turning back to FIG. 22, at block 278, the generally collinear line segments are connected to one another to form a principal wire. In this way, the principal wire is extracted from the point cloud P.

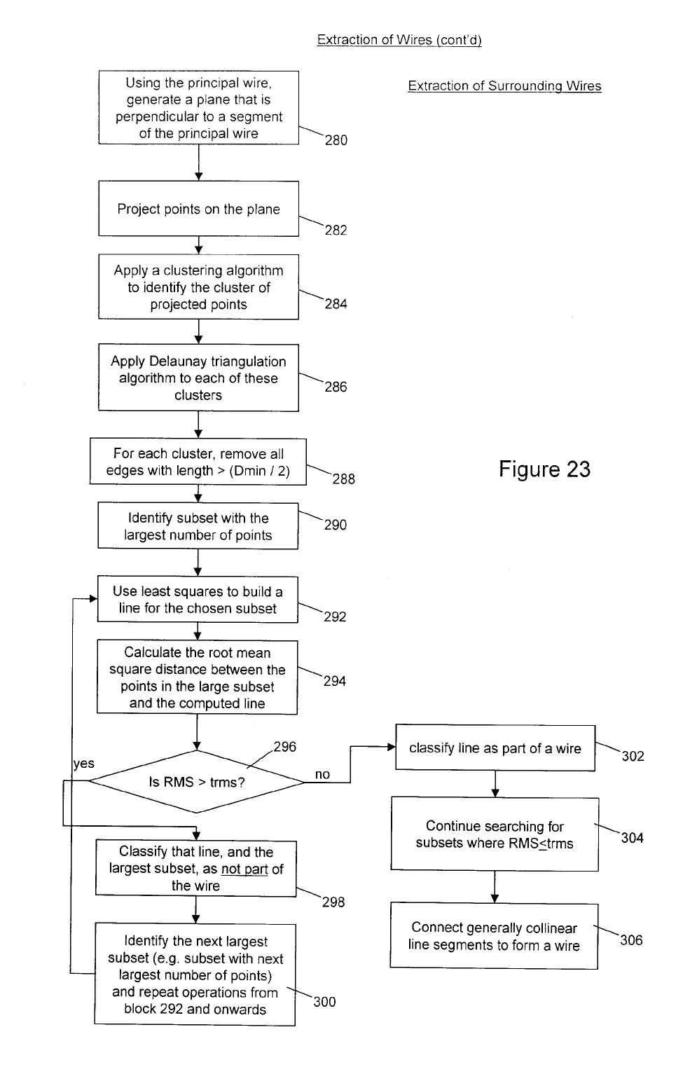

Turning to FIG. 23, example computer executable instructions are provided to extract or identify ancillary wires surrounding the principal wire. After the principal wire is identified, at block 280, a plane that is perpendicular to a segment of the principal wire is generated. At block 282, points that have projections on to the plane are identified. At block 284, a clustering algorithm (e.g. nearest-neighbour, k-means, fuzzy clustering, etc.) may be applied to identify the cluster of projected points, which would assist in identifying which points may make-up the ancillary wires. In particular, a cluster of points likely indicated the presence of an individual wire. It can be appreciated that the projection of the points are distinct from the points themselves, since the projections lie on a common plane perpendicular to the principal wire.

For example, turning to FIG. 25, a plane 316 is shown in perpendicular orientation to the principal wire 314. There may be a number points 318 that may have projections 320 on the plane 316. If the projections 320 are close together, then they may indicate the presence of ancillary wires. Turning to FIG. 26, another example of points being projected onto a plane is shown. The dense clusters or groups of points projections 322 and 324 indicate the presence of two separate ancillary wires. The sparse points 326 indicate noise.

Continuing with FIG. 23, at block 286, the Delaunay triangulation algorithm is applied to points (not the projections of the points) in each of the clusters or groupings. In this way, the points of each cluster or grouping are networked or connected together. In other words, the networked points in a cluster form a subset.

It can be appreciated that the following operations are applied to each of the clusters, since each cluster potentially represents an ancillary wire. At block 288, for each subset (e.g. cluster), all edges with a length greater than (Dmin/2) are removed or deleted. This ensures that points from other wires are not mistakenly grouped together, thereby possibly forming an inaccurately thick wire. The removal of some long edges may lead to the creation of multiple smaller subsets. These smaller subsets are still part of a common cluster, as identified earlier based on their projections onto a common plane. At block 290, the subset with largest number of points is identified and, at block 292, a line is computed through the subset using least squares. The RMS distance is determined between the points in the subset and the computed line (block 294). At block 296, it is determined whether the RMS distance is greater than the threshold trms. If not, the line is not classified as part of an ancillary wire (block 298) and the subset with the next largest group of points is identified (block 300). The operations in blocks 292, 294, 296, 298, and 300 are repeated until a subset is identified or classified to be part of an ancillary line. If the subset and the line are classified as a segment of an ancillary wire (block 302). At block 304, the computing device 20 continues to search for other subsets, which are within the cluster, having the property where the RMS distance is less than or equal to the threshold trms. At block 306, once several line segments of the ancillary wire are identified, then they are connected to construct a complete ancillary wire.

As discussed above, the above process (e.g. block 288 to block 306) applies to each cluster. In other words, if there are three identified clusters, the above process is applied three times to possibly construct three separate ancillary wires.

In another aspect, module 38 may include computer executable instructions for extracting wires (e.g. power lines, cables, pipes, rope, etc.) from a noisy environment. Noise, e.g. noisy data, in a point cloud may be created from vegetation, precipitation, birds, etc., which may surround a wire. The noise may make it difficult to extract wire features from a point cloud.

In general, a method is provided for extracting wires from a noisy environment by projecting points to a plane perpendicular to a known wire segment and analysing the density of the projections. In particular, a proposed extension of the known wire is generated to establish a “neighbourhood”. The projections of the majority of points which belong to the wire will be concentrated within the neighbourhood, whereas noisy points will be distributed outside the neighbourhood. If the density of points in the neighbourhood is sufficiently high, then the proposed extension of the known wire is accepted. These operations are repeated, whereby each iteration may add a new extension or segment to the wire.

Turning to FIG. 27, example computer executable instructions are provided for extracting wires from a noisy environment. The initial conditions assume that a line L_{R}, which represents a known wire segment, is known, and that the point cloud P includes a number of unclassified points. The known wire segment may be computed, for example, using the operations described with respect to FIGS. 21, 22 and 23. It may also be assumed that the ground surface has been identified.

At block 311, an end of the known wire segment L_{R} is assigned to be the origin (O) of a coordinate frame. At block 313, the vector of the line L_{R} is assigned to be the vector of the Y-axis. At block 315, the direction of the X-axis is computed so that the plane defined by XOY is parallel to the ground surface, or to the horizontal plane. It can be appreciated that the ground surface within the local vicinity of the origin O may likely be horizontal. At block 317, the Z-axis of the coordinate frame is computed to be perpendicular to the XOY plane.

At block 319, a first polygon (e.g. rectangle, ellipse, circle, square, etc.) and a second polygon (e.g. rectangle, ellipse, circle, square, etc.) are constructed to meet several criteria. The first and second polygons are constructed so that they both lie on the XOZ plane, and contain the origin O as its center. It can be appreciated that the line L_{R} is normal to the XOZ plane. In another criterion, the second polygon must be larger than the first polygon. In some examples, circle-shaped polygons are used to search a further distance away from the line L_{R}. In other examples, rectangular and square-shaped polygons are used to increase computational efficiency.

After the first and the second polygons are constructed meeting the above-described criteria, at block 321, a proposed line of a certain length (S) is extended from the origin O along the Y-axis, although not necessarily in the same direction as the Y-axis. In this way, the proposed line is collinear with the line L_{R}. The proposed line of length S is a proposed extension of the known wire segment. The length S may or may not change with each iteration. The length S may be determined using statistical distribution of the points around the line L_{R}. For example, if the RMS value of points around the line L_{R} is high, then the length S may be selected to be longer in order to accommodate for the greater data variability.

At block 323, each of the points, e.g. the unclassified points, may be classified as belonging to the “first neighbourhood” of the first polygon if: the point projects perpendicularly to Y onto the extended line of length S; and, the point projects parallel to Y onto the plane XOZ within the perimeter of the first polygon. The number of points that are classified as belonging to the “first neighbourhood” is represented by n1. Similarly, at block 325, each of the points, e.g. the unclassified points, may be classified as belonging to the “second neighbourhood” of the second polygon if: the point projects perpendicularly to Y onto the extended line of length S; and, the point projects parallel to Y onto the plane XOZ within the perimeter of the second polygon. The number of points that are classified as belonging to the “second neighbourhood” is represented by n2. It can be appreciated that since the second polygon is larger than the first polygon and encompasses the first polygon, then all the “first neighbourhood” points are also classified as the “second neighbourhood” points (e.g. n2≧n1). As indicated by circle E, the method of FIG. 27 continues to FIG. 28.

Continuing to FIG. 28, at block 327, the computing device 20 then determines if the following conditions are true: n1 is less than a threshold (N), e.g. n1<N; or, the maximum distance (Tmax) between a “first neighbourhood” point and the origin O is less than another threshold (Tval), e.g. Tmax<Tval. These thresholds are in place in order to prevent noise in the data from extending the line. For example, if N=3 then at least three data points must be found to extend the line. In another example, if T=S/10, then a sufficiently long piece of line must be found to extend the line. In another example embodiment, the second condition (e.g. Tmax<Tval) may be controlled by also determining how a “first neighbourhood” point is classified. In other words, by determining the dimension of the first polygon and the length S, the furthest possible distance between a “first neighbourhood” point and the origin O may be calculated. It can be appreciated that if the first condition (e.g. n1<N) is true, then the wire cannot be extended along the proposed line extension of length S, since there is an insufficient number of data points. If the second condition (e.g. Tmax<Tval) is true, then the wire cannot be extended along the proposed line extension of length S, since it is perceived that the “first neighbourhood” points do not provide sufficient information. In other words, if either condition is true, then the set of data is not validated.

Continuing to block 328, it is determined whether at least one of the conditions set out in block 327 is true. If so, at block 330, it is determined the set of “first neighbourhood” points do not provide sufficient information for, possibly, constructing an extension of the wire or line L_{R}. In order to increase the possibility of obtaining a set of valid “first neighbourhood” points, the length S of the proposed line extension is increased. The method then returns to block 321, using the increased length S, and thereafter repeats the operations set forth in the subsequent blocks (e.g. blocks 323, 325, etc.). If neither of the conditions are true, e.g. the “first neighbourhood” points provide sufficient data, then at block 332, the point densities associated with the first polygon and the second polygon are calculated. In particular, the point density D1 associated with the “first neighbourhood” is computed according to D1=n1/(area of the first polygon). Similarly, the point density D2 associated with the “second neighbourhood”, not including the “first neighbourhood”, is computed according to D2=(n2−n1)/(area of the second polygon−area of the first polygon). At block 334, it is determined if the ratio of the point densities between the different neighbourhoods exceeds a selected threshold (D0). For example, if D0=1, e.g. ratio greater than 1, then this would require that there are likely more points that represent a wire, rather than noisy points. A D0 value of less than 1 would be tolerant of noise around the wire and would cause the process to “plunge” through the noise. A D0 value of greater than 1 would be very sensitive to noise around the wire and, thus, would cause the process to stop in the presence of too much noise. In other words, it is determined if the relationship (D1/D2)>D0 is true. If so, then the proposed wire extension is extended along the length S (block 334), and the process returns to block 310 to implement another iteration for extending the length of the wire (block 338). If the relationship (D1/D2)>D0 is not true, then at block 340, the proposed wire extension is not allowed to extend along the length S. If the wire is not extended, it may be interpreted that an obstacle was found along the wire path and the wire cannot be extended through it.

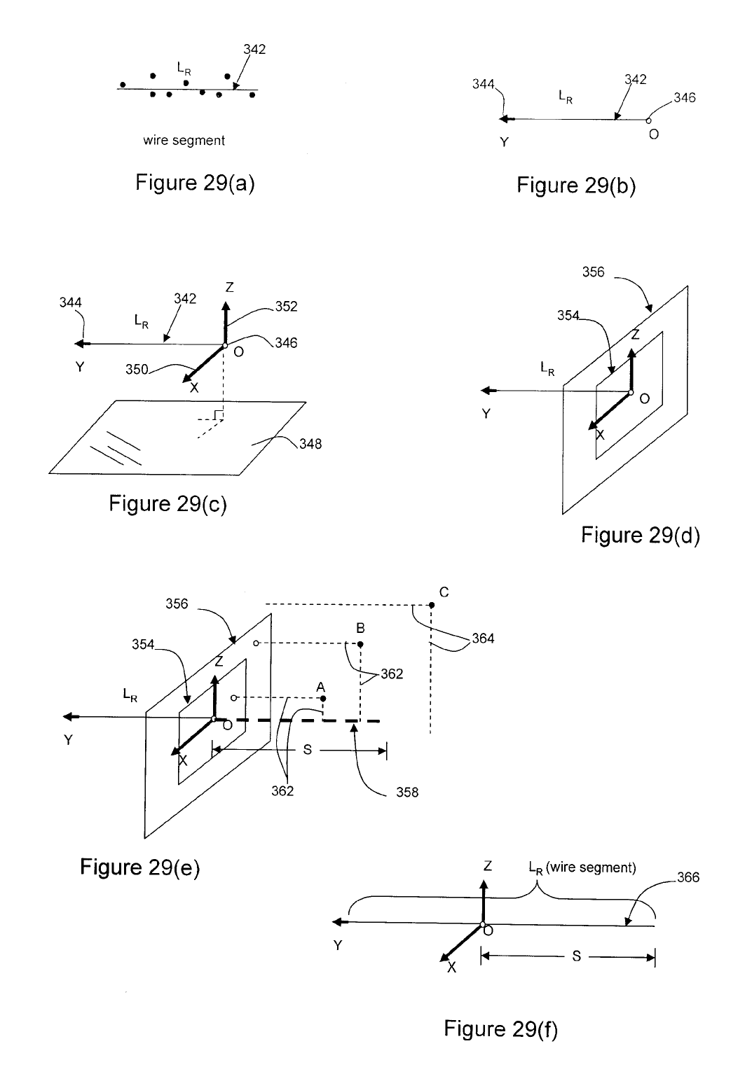

Turning to FIGS. 29(a) through 29(f), a series of illustrations are provided to show example stages for extracting a wire in a noisy environment. These illustrations generally correspond to the operations described with respect to FIGS. 27 and 28. In FIG. 29(a), a known wire segment 342 has been obtained from data points, and is represented by the line L_{R} 342. FIG. 29(b) shows the addition of the origin O 346 added to one end of the line L_{R} 342, as well as the addition of the Y-axis 344 that is collinear to the line L_{R} 342. FIG. 29(c) shows a configuration of the X-axis 350, so that the plane defined by XOY is parallel to the horizontal or ground surface plane 346. The Z-axis 352 is constructed to be normal to the XOY plane. Turning to FIG. 29(d), a first polygon 354 and a second polygon 356 are constructed in the ZOX plane. In this case, the polygons 354 and 356 are both rectangles. The first rectangle 354 has the dimensions H1, W1 and the second rectangle 356 has the dimensions H2, W2. In FIG. 29(e), a proposed wire or line extension 358 of length S is shown extending from the origin O 346. Other points A, B, C, among others, are being considered. Point A has projections onto the ZOX plane, within the area defined by the first rectangle 354, and onto the proposed line extension 358. Therefore, point A is classified as a “first neighbourhood” point. The projections for point A are illustrated with dotted lines 360. Point B has projections onto the ZOX plane, within the area defined by the second rectangle 356, and onto the proposed line extension 358. Therefore, point B is classified as a “second neighbourhood” point. The projections for point B are illustrated with dotted lines 362. Point C, as shown by dotted lines 364, does not project on to the line 358 or onto the area defined by either the first rectangle 354 or second rectangle 356. Thus, point C is neither classified as a first or second neighbourhood point. If the first neighbourhood points provide sufficient information, and the point density within the neighbourhoods is sufficiently high (e.g. see blocks 327 and 332), then a proposed line extension 358 is added to the existing or known wire line L_{R} 342. In the example of rectangles, the density values D1 and D2 may calculated using: D1=n1/(W1*H1) and D2=(n2−n1)/(W2*H2−W1*H1). The new or extended line 366 is shown in FIG. 29(f).

It can be appreciated the method described with respect to FIGS. 27 and 28 may be used in combination with the method for extracting wires, as described with respect to FIGS. 21, 22 and 23. In this way, wires can be extracted from noisy environments.

In another aspect, module 44 may include computer executable instructions for extracting the terrain and relief features of the ground from a point cloud P. In particular, it may be determined whether the ground surface is hilly, “grade” (e.g. slightly hilly), or flat, and whether the ground has vegetation or is soft (e.g. has no vegetation).

In general, the method is based on the analysis and estimation of the slopes and statistical dispersion of small local areas, e.g. sub-tiles and tiles, within the point cloud P. Since the relief and terrain are usually characteristics that are local to the earth surface, they can only be accurately calculated for small local areas. The method for extracting terrain and relief features may be based on several assumptions. A first assumption is that for local (e.g. small-size) areas with a lot of vegetation, the dispersion of data points is usually greater than for similar-sized areas without vegetation. A second assumption is that hilly areas have much bigger inclination angles towards the horizontal plane compared to flat areas. The second assumption supposes that only ground-reflected points are used for the slopes estimation (e.g. even for dense vegetation areas). It can be appreciated that the method uses a statistical approach and, thus, random errors may not likely influence the accuracy of the method's result.

Turning to FIG. 30, example computer executable instructions are provided for extracting relief and terrain features from a point cloud P. At block 370, the point cloud is separated or divided into horizontal tiles (e.g. squares) of dimension T. At block 372, each of the tiles are further separated into sub-tiles (e.g. smaller squares) of dimension A, where A<T. An example of value for T would be the width of a standard mapping tile according to many state or federal organizations standards used to subdivide digital mapping data. In particular, the tile size T would vary depending on the scale of the mapping. In many instances, when digital data is produced, it has already been subdivided into these rectangular units. The dimension A of a sub-tile is preferably chosen large enough to have a high probability of having at least one true ground surface point in each sub-tile, while balancing the desire to have small enough sub-tiles in each tile so that a large enough number of sub-tiles can accurately represent the ground surface of a tile. In one example embodiment, the sub-tile dimension A is in the range between 5 and 10 meters.

After the sub-tiles are created, a number of operations (e.g. blocks 374 and 376) are applied to each sub-tile in a tile. In particular, at block 374, any data caused by instrument error and/or by anomalies is removed or filtered out. In other words, large errors, such as gross errors caused by equipment collection malfunction, and recognised by being a multiple number of standard deviations from the mean should be removed. Natural anomalies, such as a point coincidentally measured at the bottom of a well or crevasse, could also cause such deviations and are normally removed. At block 376, the point with the lowest or elevation is identified within each sub-tile. It is likely that the lowest points are the ground points.

Continuing with FIG. 30, at block 378, for each tile in the point cloud, the lowest points from each sub-tile are connected to form a triangulation network cover. This may be performed by applying Delaunay's triangulation algorithm. In this way, a ground surface (e.g. the triangulated network cover) is constructed for each tile.

Block 380 includes a number of operations for classifying the relief of the ground surface in a tile. The operations in block 380 include using the triangles formed by the triangulation network cover (block 382). These triangles may also be referred herein as ground surface triangles. The inclination angle between each ground surface triangle and the horizontal plane is measured. The inclination angle may also be determined by measuring the angle between the normal of a ground surface triangle and the vertical axis. After determining the inclination angles for each triangle in the tile, at block 384, the number of triangles with inclination angles greater than some angle (Incl. 1) is determined. Similarly, the number of triangles with inclination angles between Incl.2 and Incl.1 is determined, and the number of triangles with inclination angles less than Incl.2 is determined. It can be appreciated that Incl.2<Incl.1. In an exemplary embodiment, Incl.1=10° and Incl.2=5°. As indicated by circle F, the method of FIG. 30 continues to FIG. 31.

Continuing to FIG. 31, at block 386, if the number of triangles, having inclination angles more than Incl.1, is greater than some percentage μ1 of the total number of triangles in the tile, then the tile is classified as “hilly”. If the number of triangles, having inclination angles between Incl.2 and Incl.1, is greater than some percentage μ2 of the total number of triangles in the tile, then the tile is classified as “grade”. If none of those conditions are true, then the tile is classified as “flat”. In an exemplary embodiment, the value of the parameters are: Incl.1=10°; Incl.2=5°; μ1=20%; and μ2=20%.

Continuing with FIG. 31, another set of operations (block 388) are used to classify whether a tile has vegetation or not. A number of operations (blocks 390, 392, 394) are applied to each sub-tile in a tile. In particular, at block 390, it is determined if a sub-tile has at least a certain number of points (n-sub), e.g. n-sub=10 points. If not, at block 392, the sub-tile is not considered in the calculation since it is considered to have insufficient data. If the sub-tile does have enough data points, then at block 394, the standard deviation of the points' heights from the ground surface is determined for the sub-tile.

After collecting the standard deviations of heights associated with many, if not all, sub-tiles within the tile, the number of sub-tiles having a standard deviation of more than a certain height (Hdev) is determined (block 398). This accounting of sub-tiles is determined for each tile. An example standard deviation height Hdev is 1 meter. It can be understood that a higher number of sub-tiles with a large standard deviation may indicate that there is more variation of height in the data points. A higher variation of height may indicate the presence of vegetation.

In particular, at block 398, it is determined if the number of sub-tiles, having a standard deviation of more than Hdev, exceed a certain percentage ω (e.g. ω=15%) of the total number of sub-tiles that were considered within the tile. It can be appreciated that varying the values of the standard-deviation threshold Hdev and the certain percentage may change the sensitivity for the terrain classification. These values, for example, may be empirically tuned. If the condition at block 398 is true, then at block 402 the tile's terrain is classified at “vegetation”. If not, then at block 400 the terrain is classified as “soft” (e.g. no vegetation).

It can thus be seen that the relief and the terrain classification may be used characterize a tile as one of: hilly and vegetation; hilly and soft; grade and vegetation; grade and soft; flat and vegetation; or, flat and soft (block 404). In one embodiment, the relief and terrain extraction module 44 can be used to automatically determine the relief and vegetation classification of a tile (or data set) so that different sets of criteria can be automatically applied in the ground surface extraction module 32.

In another aspect, the set of data points and the extracted features can be used to form a base model. More generally, a base model is a three-dimensional representation of space or of objects, or both, that is created using point cloud data. A base model, which is stored in the base model database 520, is located or defined within a suitable global coordinate system such as the Universal Transverse Mercator (UTM) coordinate system or the Earth-centered, Earth-fixed (ECEF) Cartesian coordinate system. Data subsets within the base model may be associated with different epochs of time.

A base model may be enhanced using external data 524, such as images 526 and other data with spatial coordinates 528. Image 526 may include images showing color, temperature, density, infrared, humidity, distance, etc. It is known that there are different types of images that can show various types of data, and these images can be used in the principles described herein.

In some cases, it is desirable to enhance the base model with different types of data, or more data points. In this way, the enhanced base model may convey more information. Further, the external data provided in the form of an image or other data having spatial coordinates is also enhanced when combined with the base model, since the base model provides context for the external data.

In a particular scenario, two-dimensional sensors, such as digital cameras of various operating spectre, are capable of acquiring high resolution images providing high relative accuracy and definition of the objects. However, the images acquired can lack spatial information and absolute geographic accuracy. Similarly, three-dimensional scanning techniques can produce accurate and detailed models, but also lack accurate geo-referenced positioning. Such drawbacks of the accurate location positioning is remedied by combining the external data with the base model.

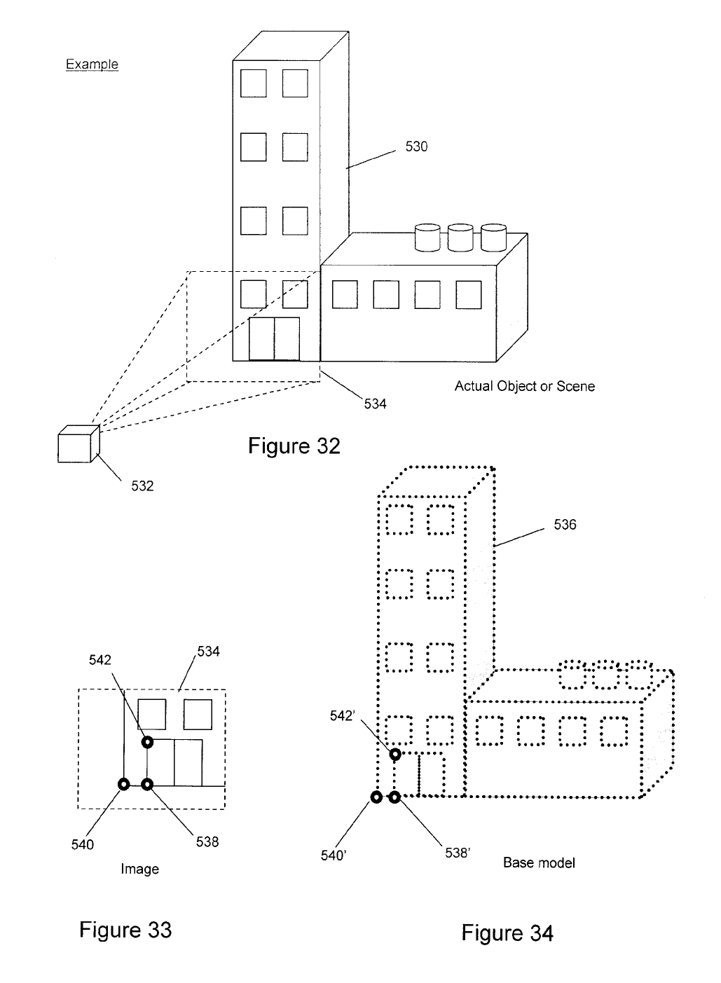

Turning to FIGS. 32, 33 and 34, an example scenario of enhancing a base model of a building 536 is provided. The base model 536 may be constructed or captured from data points 26, which are typically obtained by interrogating the actual building 530 using LiDAR equipment. Alternatively, the base model 536 may be extracted from the data points 26 according to the principles described above (e.g. modules 34, 40, and 42).

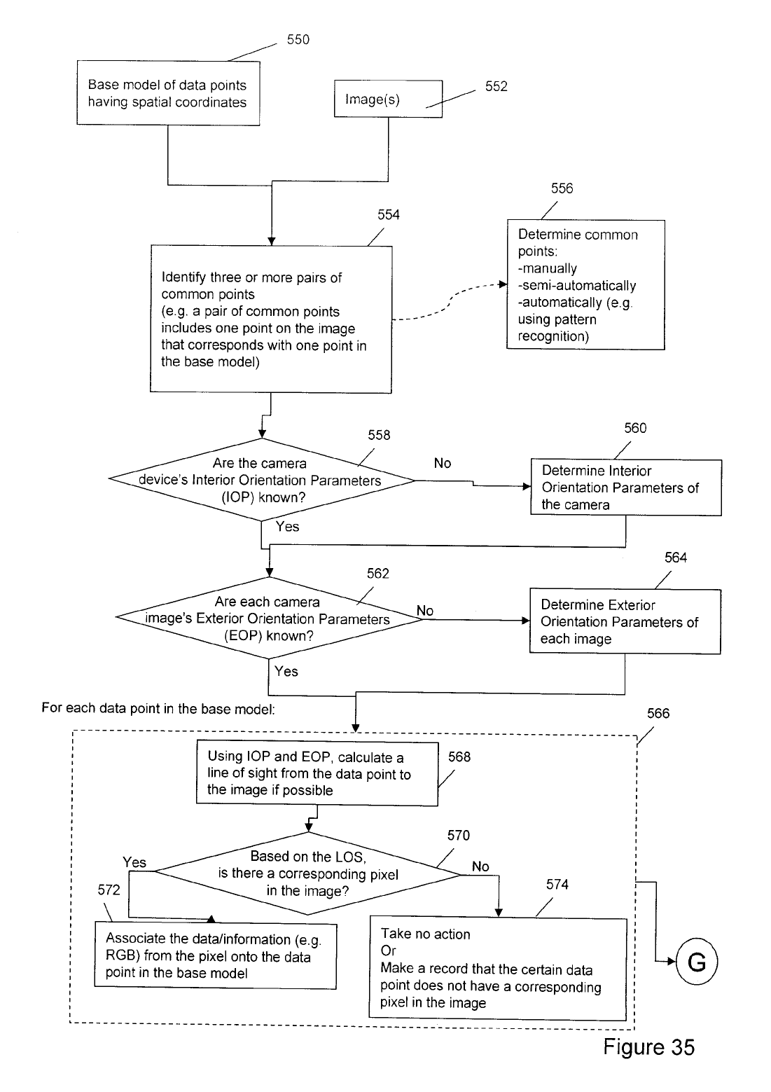

As can be best seen in FIG. 32, a camera device 532 captures an image 534 of at least part of the building 530. In FIG. 33, the image 534 contains some points that are common to points in the base model 536 shown in FIG. 34. Non-limiting examples of common points include corners, lines, edges, etc., since these are more conveniently identifiable. Pairs of common points include points 538 and 538′; points 540 and 540′; and points 542 and 542′, which show points corresponding to corners. It can be appreciated that the pairs of common points may be identified manually (e.g. an operator manually identifies and selects the common points), automatically (e.g. known computer algorithms related to pattern recognition, edge detection, etc. automatically identify common points), or a combination thereof (e.g. semi-automatically). The pairs of common points are used to determine transformation and mapping parameters to combine the data of the image 534 with the base model 536. The process of enhancing a base model is described further below.

In other applications, remote sensing imagery (e.g. satellite images, aerial photography) of buildings, landscapes, water, terrain, etc. may be combined with a corresponding base model. Further, X-RAY images of bones, or internal structures may be combined with a corresponding base model. In general, where a camera-type device is used, the location of the pixels in the image typically requires configuration to match the camera's coordinate system (e.g. interior orientation). The adjusted location of the pixels is then further configured to determine the position and angular orientation associated with the image (e.g. exterior orientation). In other words, the interior orientation is the reconstruction of a bundle of image rays with respect to a projection centre. The exterior orientation describes the location and orientation of an image in an object coordinate system. It can be appreciated that the processes and methods of interior orientation and exterior orientation are known, and are used herein as described below.

Turning to FIG. 35, example computer executable instructions are provided for enhancing a base model using an image. The computer executable instructions may be implemented by module 500. At block 550, a base model of data points having spatial coordinates is provided. At block 552, one or more images are also provided. It can be appreciated that at least a portion of the image corresponds with at least a portion of the base model. At block 554, one or more pairs of common points are identified. As described above, a pair of common points includes one point on the image that corresponds with one point in the base model. As per block 556, the common points can be manually identified, semi-automatically identified, or automatically identified. At block 558, it is then determined whether the camera's interior orientation parameters (IOP) are known. Non-limiting examples of the IOP include tangential distortion of the camera lens, radial distortion of the camera lens, focal length, and principal point offset (e.g. in the X and Y dimensions). These parameters are called Interior because they are specific to the camera device. They do not change from image to image for the same camera device but they do change from one device to another. The IOP of the camera device may be known beforehand, e.g. when the image was taken, and may be provided in a camera calibration report. At block 560, if the IOP are not known, then they are determined using a variety of known camera calibration methods.

An example of this would involve mathematically comparing pairs of points; that is, one of each pair being on an object of known precise dimensions, such as the measured grid intersections of horizontal and vertical lines, and the other of each pair being on the precisely measured camera image that is produced by these points. The Interior Orientation Parameters (IOP) of the camera are calculated including the focal length, the principal point offset (in X and Y) and the tangential and radial distortion of the lens.

Once the IOP are obtained, it is determined whether or not the exterior orientation parameters (EOP) are known, as per block 562. Non-limiting examples of the EOP include the XYZ coordinates or position of the camera's perspective center within the base model coordinate system, and the camera's orientation with respect to the base model coordinate system. The orientation is described by a series of rotations of three angles around three perpendicular body coordinate axes, namely roll, pitch and heading (typically referred to as Omega, Phi and Kappa). These parameters are called Exterior because they are exterior to the camera device. They change from one image to another and they represent the position, angle and direction the camera was pointing when it took each image. However, if the EOP is not known, then the EOP are determined (block 564). The EOP may be determined using known methods, such as using a typical “photogrammetric bundle adjustment” that also involves using a combination of common points, lines and measured distances located on the image and the base model. Another known photogrammetric method that can be applied is aero-triangulation.

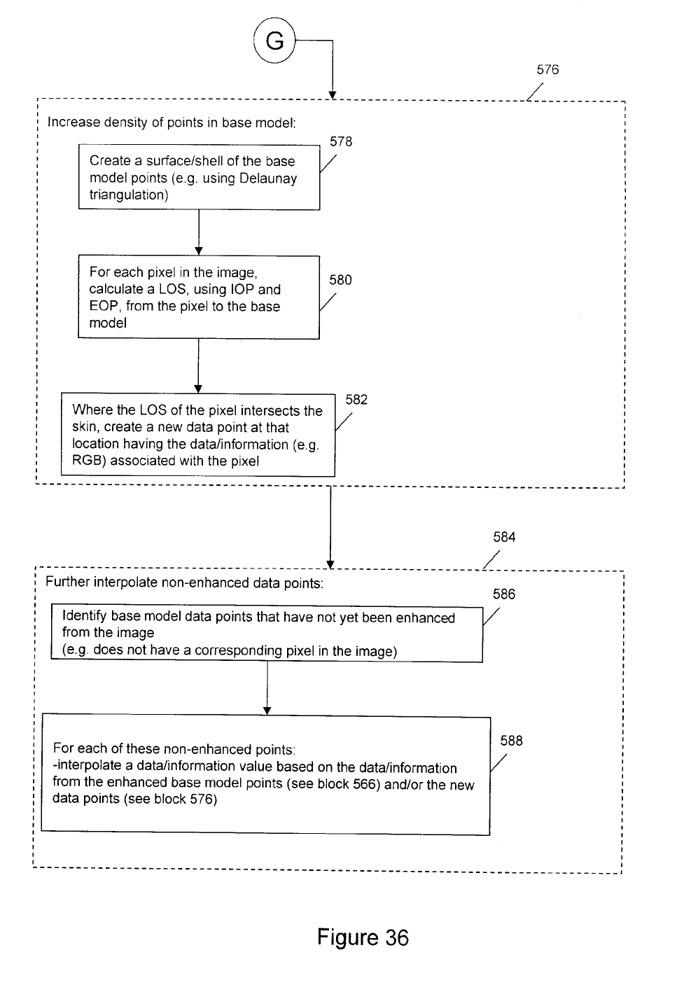

Upon obtaining the EOP and the IOP, these parameters are then used to integrate the data from the images with the base model (e.g. data points with spatial coordinates). In particular, at block 566, a number of operations are carried out for each data point in the base model. At block 568, using the IOP and the EOP, colinearity equations are used to mathematically project a line of sight from each data point of the Base Model onto the image, if possible. The IOP, EOP and line of sight can be considered mapping information to associate data points in the base model with one or more pixels in the image. At block 570, based on the lines of sight, it is determined whether or not the data point has a corresponding pixel in the image. As FIGS. 33 and 34 show, not all data points of the base model may have a corresponding pixel in the image. If there is a corresponding pixel, at block 572 the data or information associated with the corresponding pixel is mapped onto or associated with the data point of the base model. In another embodiment, not shown, a new (i.e. different) data point is created in the base model having the same coordinates as the already existing data point. Then the data or information associated with the corresponding pixel is mapped onto or associated with the new data point, which has the same location coordinates as the already existing data point. At block 574, if there is no pixel in the image that corresponds to the subject data point in the base model, then no action is taken. Alternatively at block 574, the computing device 20 makes a record that the subject data point does not have a corresponding pixel in the image. As indicated by circle G, the method of FIG. 35 continues to FIG. 36.

Continuing with FIG. 36, at block 576, the computing device 20 carries out a number of operations to increase the number of data points in the base model. In particular, at block 578, a surface or shell of the base model points is created (e.g. using Delaunay triangulation). It can be appreciated that the surface or shell of the base model may have been created previously using one or more of the above described methods (e.g. modules 32, 34, 36, 38, 40, 42, 44) and then the surface or shell is obtained in block 578 for use. At block 580, for each pixel in the image, a line of sight (LOS) is calculated between a subject pixel and the base model. The LOS is calculated using the IOP and the EOP proceeding from each pixel on the image, through the perspective centre and onto a location on the surface of the base model. At block 582, at the location of where the LOS of the subject pixel intersects the surface or shell, a new data point is created. The new data point located on the surface or shell of the base model, and coincident with the LOS, is created to include data or information associated with the subject pixel. In other words, if a certain pixel of the image included color (e.g. RGB) data, then the corresponding new data point in the base model will also include the same color data or information. In another example, if a certain pixel of the image included infrared data, then the corresponding new data point in the base model will also include the same infrared data. The operations within block 576 are repeated for each of the pixels in the image. Thus, for each pixel in the image, if the pixel does not have a corresponding data point in the base model, then a new data point is created having the same data or information as the pixel. The addition of the new data points to the base model at block 576 and the enhancement of certain data points of the base model at block 566 creates an enhanced base model.

In another embodiment, not shown, the operations of block 566 are not executed or performed and, instead, the operations of block 576 are performed for each and every pixel in an image. Therefore, in such an example embodiment, if there are five-hundred pixels, then five-hundred new data points are created. In this way, an enhanced base model is created.

Continuing with FIG. 36, at block 584, operations are provided for interpolating data or information corresponding to the locations of data points in the base model that have not yet been enhanced. In other words, for data points in the base model that have not yet been enhanced using the data or information from the image, these data points are provided with interpolated values based on the data or information from the image. In particular, at block 586, the base model data points that have not yet been enhanced by the image are identified. For example, data points in the base model that do not have a corresponding pixel in the image would not have been enhanced. It is possible that such data points may have been obtained earlier in block 574, and more quickly retrieved later in block 586. For each of these non-enhanced points, at block 588, the data or information values that have been derived from the image and are present in the points in the enhanced base model are used to interpolate data or information of the same type. In other words, the computing device 20 interpolates a data or information value for a non-enhanced point based on the data or information from the enhanced based model points. For example, if the enhanced base model points include color data (e.g. RBG values) which have been derived from a color image, then using the color data of the enhanced base model point, the RBG values are interpolated or estimated for the non-enhanced data points of the base model. Examples of known interpolation and estimation methods that can be applied include least squares, linear interpolation, nearest neighbour, weighted averages, etc.

It can therefore be appreciated that the base model is enhanced through any one of mapping data values of an image to corresponding data points in the base model (block 566), increasing the density of points in the base model (block 576), interpolating values for base points (block 584), or combinations thereof. The enhanced base model has data points representing information obtained or derived from the image and whereby the data points also have spatial coordinates. As described earlier, various types of image data or information can be used to enhance the base model, such as color, temperature, pressure, distance, etc.

An example of an engineering application of this process would be to create thermal models which are accurately positioned in space and which are taken at different epochs in time to investigate the temperature of the surface of objects and structures over time heated and cooled either artificially or naturally.

Another example application would be the addition of colour to an accurate geo-referenced base model of scanned points in space and then using the differences in colour to automatically identify and extract objects from the subsets of data. In this way manholes can be automatically identified on a flat road surface and extracted as separate objects. Windows, doors and architectural detail can be automatically identified on a building edifice and automatically extracted. Scanned objects of merchandise can be coloured and textured and common colours used to automatically separate the object into its component parts such as the upholstery parts of a chair and the metal parts of a chair.

Therefore, in general a method is provided for a computing device to enhance a set of data points with three-dimensional spatial coordinates using an image captured by a camera device. The method comprises: the computing device obtaining the image, the image comprising pixels, each of the pixels associated with a data value; the computing device generating mapping information for associating one or more data points and one or more corresponding pixels; and the computing device modifying the set of data points using the mapping information and the data values of the one or more corresponding pixels. In another aspect, generating mapping information comprises: obtaining one or more interior orientation parameters of the camera device; obtaining one or more exterior orientation parameters of the camera device; and projecting a line of sight from the one or more data points onto the one or more corresponding pixels using at least one of the one or more interior orientation parameters and the one or more exterior orientation parameters. In another aspect, modifying the set of data points using the mapping information comprises associating one or more data points with the data value of the corresponding pixel. In another aspect, modifying the set of data points using the mapping information comprises: adding a new data point for an existing data point, the existing data point being one of the one or more data points and having a corresponding pixel, the new data point having the same spatial coordinates as the existing data point; and associating the new data point with the data value of the corresponding pixel. In another aspect, generating mapping information comprises: obtaining one or more interior orientation parameters of the camera device; obtaining one or more exterior orientation parameters of the camera device; generating a triangulated surface using the set of data points; and projecting a line of sight from one or more pixels onto one or more corresponding locations on the triangulated surface using at least one of the one or more interior orientation parameters and the one or more exterior orientation parameters. In another aspect, modifying the set of data points using the mapping information comprises: adding a new data point to the set of data points, the new data point located at one of the one or more corresponding locations on the triangulated surface; and associating the new data point with the data value of the pixel corresponding to the location of the new data point. In another aspect, modifying the set of data points using the mapping information comprises: identifying one or more data points not having a corresponding pixel; and modifying the one or more data points not having a corresponding pixel based on one or more data points associated with the data values of the one or more corresponding pixels. In another aspect, modifying the one or more data points not having a corresponding pixel comprises associating the one or more data points not having a corresponding pixel with information interpolated from the one or more data points associated with the data values of the one or more corresponding pixels. In another aspect, generating mapping information further comprises generating a base model of one or more data points corresponding to at least a portion of the image.

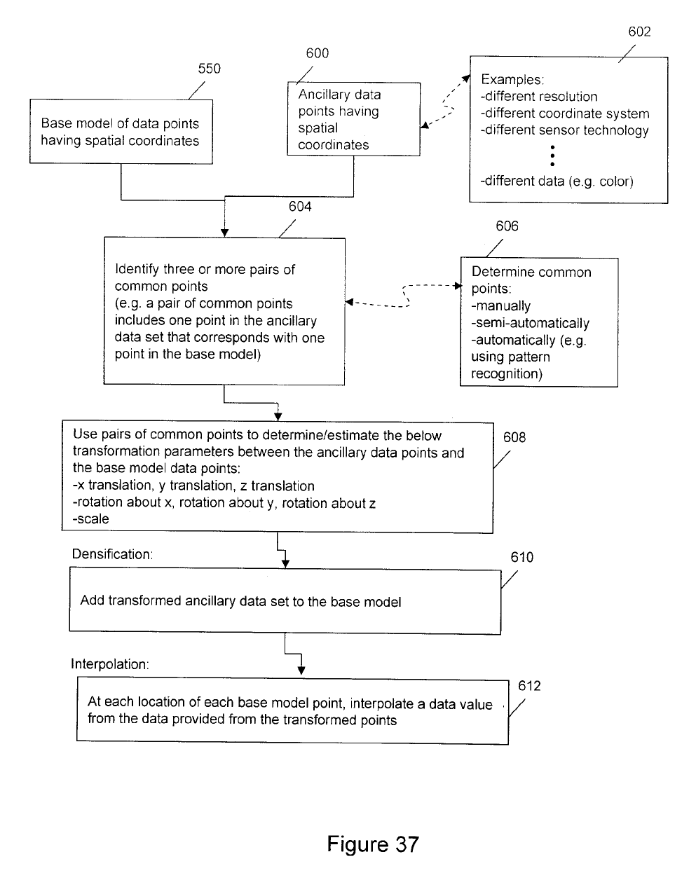

Turning to FIG. 37, example computer executable instructions are provided for enhancing a base model using ancillary data points having spatial coordinates (e.g. data 528). The computer executable instructions may be implemented by module 502. Similar to the method described with respect to FIG. 35, a base model of data points having spatial coordinates is required (block 550). Further, a set of ancillary data points having spatial coordinates is also required (block 600). The ancillary data points or external data points are typically, although not necessarily, different in some way from the base model points. As shown in block 602, the ancillary data points as compared with the base model data points may have different resolution (e.g. lower or higher resolution), a different coordinate system (e.g. polar coordinates), a different sensor technology (e.g. LiDAR, X-Ray, RADAR, SONAR, infrared, gravitometer, etc.), and a different type of data (e.g. color, temperature, density, type of material, classification, etc.). It is readily understood that there may be other differences between the ancillary data points as opposed to the base model data points.

Continuing with FIG. 37, at block 604, the computing device 20 identifies pairs of common points. In a pair of common points, one point in the ancillary data set corresponds with one point in the base model. As indicated in block 606, the pairs of common points are identified manually, semi-automatically, or fully automatically (e.g. using known pattern recognition and matching algorithms). The points may be manually selected in both the ancillary data set and the base model by pointing manually at visible features in the displayed views of the point clouds. More automated and accurate selections can be achieved by refining the selections using an Iterative Closest Point (ICP) algorithm. The ICP algorithm is known in the art, and is typically employed to minimize the difference between two clouds of points. The ICP algorithm iterates the following operations: associate points by the nearest neighbor criteria; estimate transformation parameters using a mean square cost function; and transform the points using the estimated parameters. Another way to automate the selection of control point pairs or to refine and verify the pairs of common points would be by pattern matching in 3D. The pattern matching may be based on RGB colour or (laser) intensity data, if such information is available in both point cloud models (i.e. present in both the ancillary data set and the base model). A combination of the above methods could also be used.

In a preferred embodiment three or more pairs of common points are identified to estimate a set of transformation parameters. However, other known transformation algorithms requiring more or less common data points are also applicable to the principles described herein.

At block 608, using the three of more pairs of common points, a set of transformation parameters are estimated, so that the set of ancillary data points can be transformed to match the coordinate system and coordinate reference of the base model. In one typical embodiment, there are seven transformation parameters that include x-translation, y-translation, z-translation, rotation about the x-axis, rotation about the y-axis, rotation about the z-axis, and the scale factor. It can be appreciated that the calculation of these seven parameters is known in the art. It is also appreciated that more pairs of common points will provide the possibility of a least squares adjustment or “best fit” as well as a measurement of the accuracy of the transformation.

Upon determining the transformation parameters, or mapping information, the parameters are used to transform the ancillary data set to be compatible with the base model. At block 610, the density of the base model is increased by adding the transformed ancillary data set to points in the base model. In other words, the base model is enhanced by adding a number of data points. At block 612, at each location of each base model point, the computing device 20 interpolates a data value based on the data provided from the transformed ancillary data points. In other words, at the location of each base model point, a value is associated with the base model point, whereby the value is determined through interpolation of the data of the transformed ancillary data points. The addition of the transformed ancillary data points, the interpolated data values of the base model points, or both, therefore provide an enhanced base model.

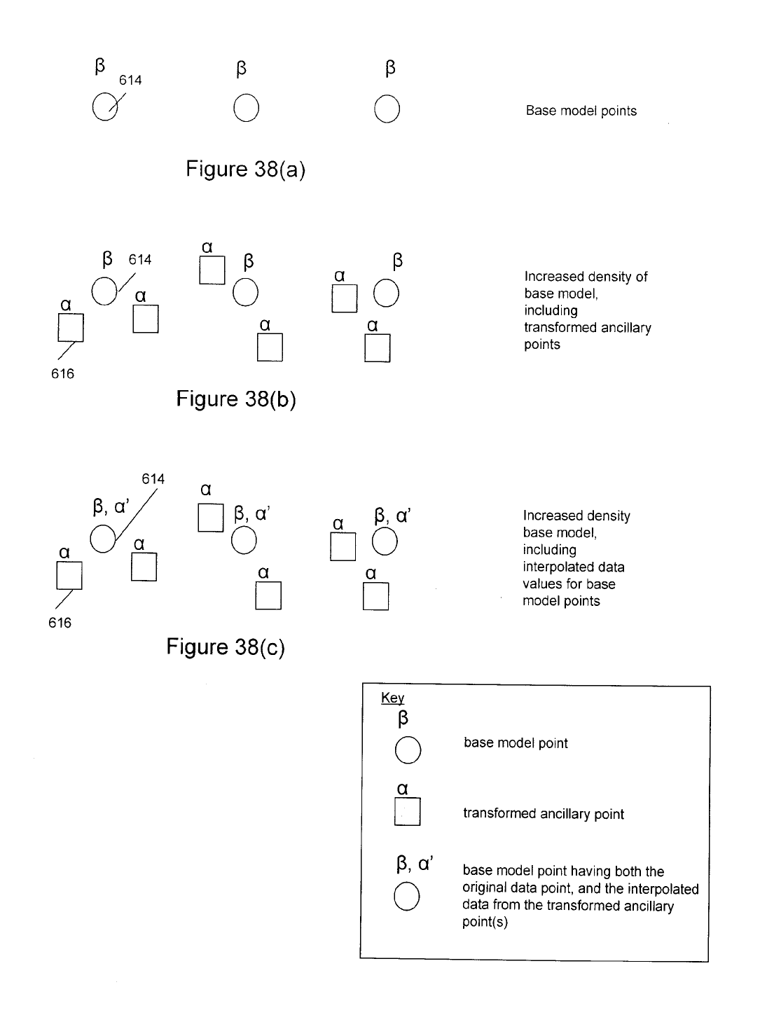

FIGS. 38(a), 38(b) and 38(c) illustrate different stages of the method described with respect to FIG. 37. In particular, FIG. 38(a) shows a number of base model points 614 in some space. The base model points 614 are represented with a circle, and the associated type of data or information is represented by the symbol β. FIG. 38(b) shows the base model points 614 and the addition of the transformed ancillary data points 616 sharing the same vicinity. This corresponds to block 610. The locations of the transformed ancillary data points are represented with a square, and the associated type of data or information is represented by the symbol α. In this example, the ancillary data points have a different type of data or information (i.e. a) compared with the base model points (i.e. β). FIG. 38(c) shows that at the location for each of the base model points 616, in addition to the data β, interpolated data values of the data type α are associated with the base model points 616. The interpolated data values associated with the base model data points are symbolically represented as α′. Example interpolation methods such as nearest neighbour, linear interpolation, least squares, weighted averages, or combinations thereof, may be used. It can also be appreciated that, in one example, the data type β may represent the intensity value of a laser reflection, while the data type a may represent color (e.g. RGB value).

Therefore, in general, a method is provided for a computing device to enhance a set of data points with three-dimensional spatial coordinates using a set of ancillary data points with three-dimensional spatial coordinates. The method comprises: the computing device obtaining the set of ancillary data points, each ancillary data point associated with a data value; the computing device generating mapping information for transforming the set of ancillary data points to be compatible with the set of data points; and the computing device modifying the set of data points using the mapping information. In another aspect, generating mapping information comprises: identifying three or more data points with a corresponding ancillary data point; and obtaining a set of transformation parameters based on the three or more data points and the corresponding ancillary data points. In another aspect, the set of transformation parameters comprise x-translation, y-translation, z-translation, rotation about an x-axis, rotation about a y-axis, rotation about a z-axis, and a scale factor. In another aspect, modifying the set of data points using the mapping information comprises: transforming one or more ancillary data points to be compatible with the set of data points using the mapping information; and adding the transformed one or more ancillary data points to the set of data points. In another aspect, modifying the set of data points using the mapping information comprises: transforming one or more ancillary data points to be compatible with the set of data points using the mapping information; and associating one or more data points with information interpolated from one or more of the transformed ancillary data points. In another aspect, data points are associated with a different data type than the ancillary data points.

The above methods for enhancing a base model using external data can also be applied to tracking objects over time. In particular, a certain object in a set of images taken over time may be accurately located within a base model (e.g. point cloud). Depending on the resolution of the images and the base model, it is possible that the location of a certain object may be accurately determined to within centimetres. This allows objects to be tracked over time and space (e.g. location, position) and can have many surveillance and monitoring applications. For example, video images of a car driving throughout a city can be used in combination with a base model of a city to track the exact location of the car, and where it moves. Similarly, images of a forest that is being lumbered or cut down can be combined with a base model to determine the rate of deforestation. Based upon the time dependent spatial information, the trajectory, dynamics and kinematics of objects can be determined. Another example is the accurate monitoring of the speed of all athletes or vehicles at each and every instant of a game or race. The base model would be the empty track or field. In this way not only the speeds but also the directions, velocities and accelerations of the players and vehicles can be monitored throughout the game or race. It can be appreciated that there may be many other applications.

In general, point cloud data of a base model can be combined with external data having time information, such that the base model is enhanced to have four dimensions: x, y and z coordinates and time. In one scenario related to analyzing moving objects, subsequent registered images are used, whereby each image (e.g. frames of a video camera, or photos with time information) is provided a time stamp. To support an accurate dynamic or kinematic analysis of a moving object, the time tags associated with the images have to be synchronized and refer to the same zero epoch.

In order to accurately determine the three-dimensional position of an identified object based on an image of the object, a tracking point is selected on a portion or point of the object in the image. Preferably, although not necessarily, the tracking point in the image is selected at a location where the object touches or is very close to an object in the base model. By selecting a tracking point that is in close vicinity to or in contact with the base model, then the base model can be used a stationary position reference to identify the location of the moving tracking point. When the moving object is not located near or in contact with the base model, such as for a flying object, the location of the tracking point in the base model can be determined by estimating a point on the base model immediately beneath the moving object or immediately behind the moving object for example on a building wall behind the object and parallel to the direction of movement. In such a case ideal camera placement would be to view the wall and moving object from a perpendicular direction to get more accurate position and velocity readings as the object flies by. It can be appreciated that the moving object itself, may not necessarily be part of the base model.

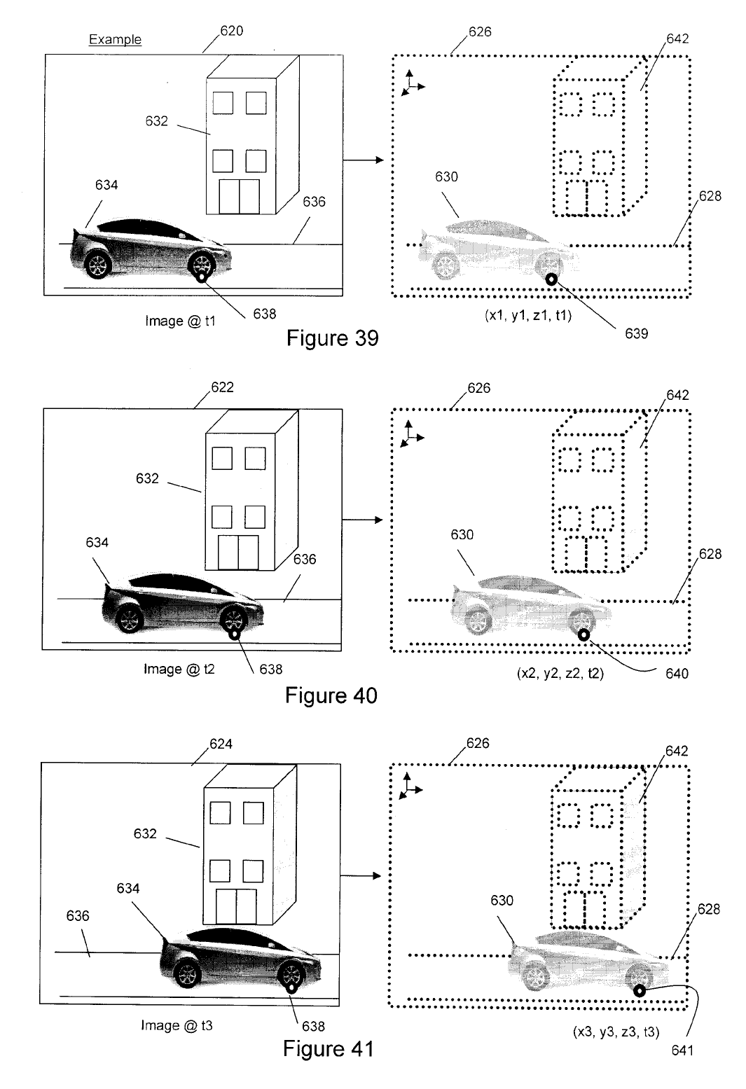

Turning to FIGS. 39, 40 and 41, in one example, to accurately track the velocity of a moving car 634, a tracking point 638 is selected to be at the location where the car's wheel visibly touches the ground or road 636. By tracking this location on the ground 636 in consecutive frames 620, 622, 624 the movement (e.g. velocity, acceleration, angular velocity, etc.) of the car 634 can be determined. The tracking point 638 can be placed anywhere in an image on a moving object, whereby the tracking point is visible in one or more subsequent images.

Turning to FIG. 39, an image 620 (e.g. photo, frame of a video, etc.) taken at a first time t1 is provided. Thus, a time stamp t1 is associated with the image 620. The image 620 shows a car 634 on a ground 636, driving by some scenery, such as a building 632. A base model 626 is also shown, which comprises a point cloud of a number of objects in an environment. In particular, the base model 626 also includes a number of data points representing a building 642 and a road 628, which correspond to the building 632 and the road 636 in the image 620. It is readily understood that the data points in the base model 626 each have spatial coordinates and, thus, the location of each point on an object (e.g. the building 642 and the road 628) in the base model 626 is known. In this example, the car 630 is not part of the base model 626, although a representation of the car 630 can be added into the base model 626 based on the information obtained from the image 620. In one embodiment, the car 630 is an object comprising data points, or a wire frame, or a shell, and is stored in the objects database 521. The car 630 would be sized to be proportional to the base model 626.

Continuing with FIG. 39, the tracking point 638 in the image 620 corresponds with one or more pixels in the image 620. Once certain camera and image parameters are known (e.g. IOP and EOP), the one or more pixels can be mapped onto a surface of the base model 626. In particular, a line of sight from a pixel to the surface of the base model 626 is determined, and the intersection of the line of sight and the surface of the road 628 becomes the location of a new point 639 in the base model 626. The new point 639 corresponds with the tracking point 638 in the image 620. The new point 639 is a four-dimensional point having location coordinates and a time parameter corresponding to the time stamp of the image 620. Thus, the new point 639 is represented by the parameters (x1, y1, z1, t1).

In FIG. 40, a similar process takes place with a second or subsequent image 622 of the car 634. The image 622 is taken at a second time t2, and shows the car 634 moving in a forward direction relative to image 620. The position of the tracking point 638 (e.g. where the wheel meets the ground 636) is then mapped again onto the base model 626, and at that mapped location a new point 640 in the base model 626 is created. The new point 640 is associated with the tracking point 638 obtained from the image 622 at time t2, and thus as different set of parameters (x2, y2, z2, t2).

FIG. 41 provides another image 624 captured at a third time t3. Again, the tracking point 638 in the image 624 is mapped onto the base model 626. Based on the mapping, another new data point 641 is created in the base model 626, having four-dimensional parameters symbolically represented as (x3, y3, x3, t3).

The data collected from the series of images 620, 622, 624 have been used to derive a number of new data points 639, 640, 641 having time stamps corresponding to the images. The new data points 639, 640, 641 accurately provide the spatial coordinates and times of the tracking point 638 in the images 620, 622, 624. Thus, the new data points 639, 640, 641 can be used to determine different movement characteristics of the car 634.

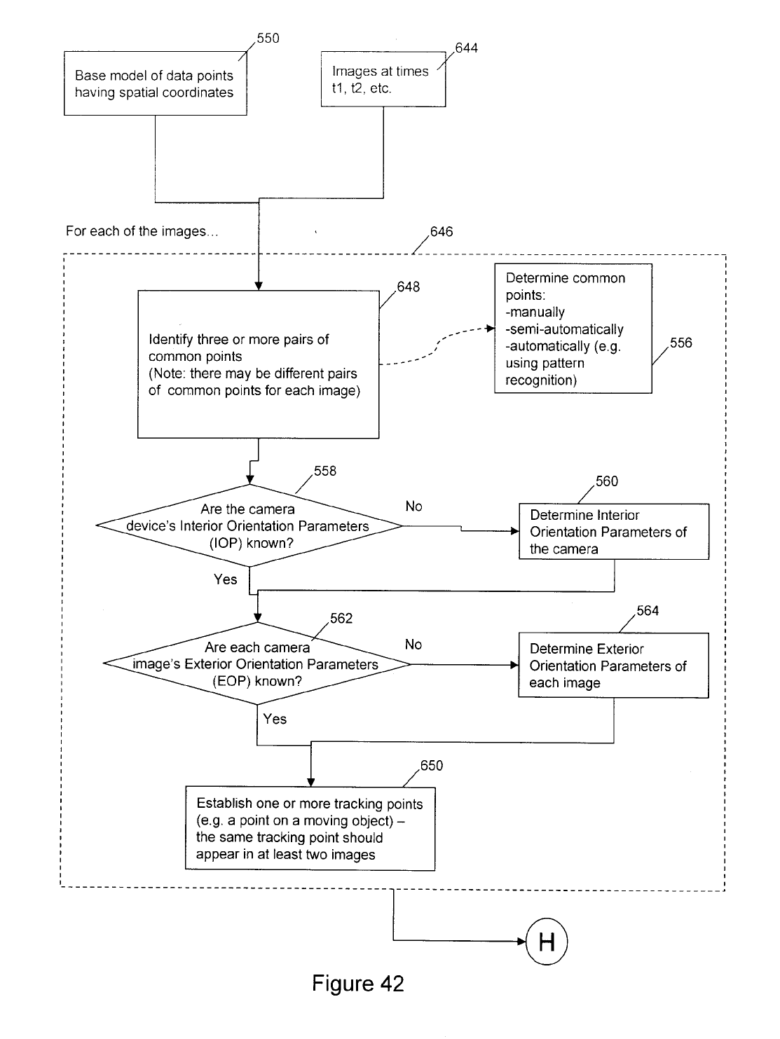

Turning to FIG. 42, example computer executable instructions are provided for tracking a moving object using images to enhance a base model. The computer executable instructions may be implemented by module 504. At block 550 a base model of data points having spatial coordinates is obtained. The base model, as described above, may also include extracted features such as those stored in the extracted features database 30. At block 644, two or more images are obtained, the images captured at different times.

At block 646, a number of operations are provided for adjusting each of the images so that one or more tracking points in each of the images can be mapped onto the base model. In particular, for each image, at block 648, a minimum of three or more pairs of common points are identified. As per block 556, the common points can determined manually, semi-automatically, or automatically. Typically, the pairs of common points would not be on a moving object itself (e.g. the object to be tracked), but rather part of the scenery or environment. It is noted that there may be different pairs of common points in each image. For example, in one image, the pairs of common points may be on a building, while in a subsequent image, the pairs of common points may be on bridge.

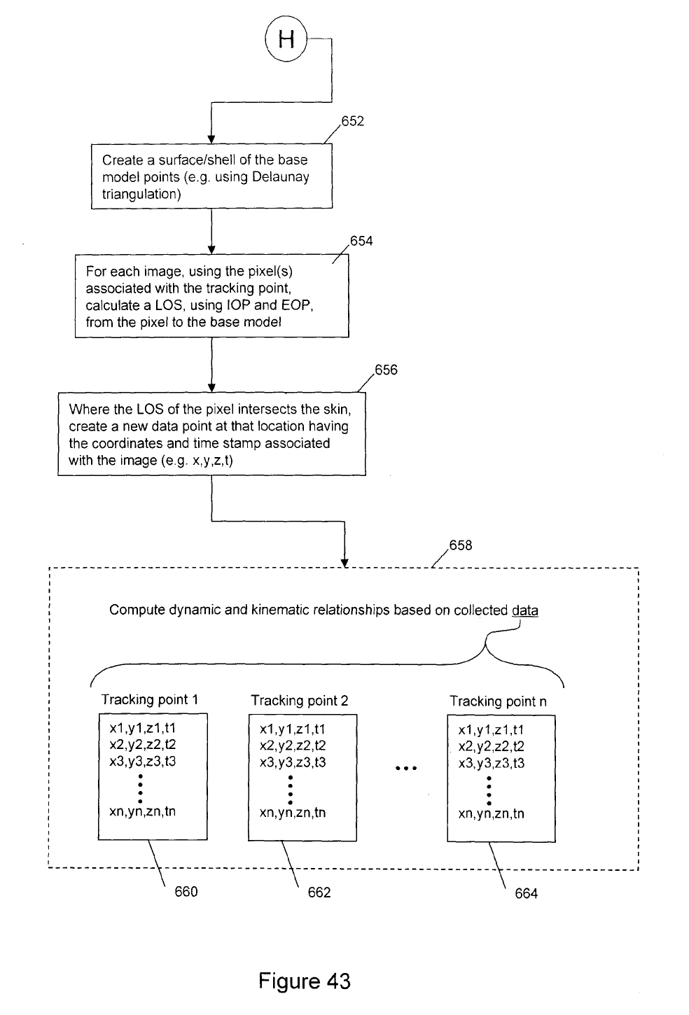

At block 558, it is determined whether or not the IOP are known. If not, at block 560, the IOP are determined, for example using camera calibration techniques. The computing device 20 also determines if the EOP are known (block 562) and if not, determines the EOP (block 564) using, for example, photogrammetric bundle adjustment. It can be appreciated that the methods of determining the IOP and EOP were discussed above with respect to FIG. 35 and may be used here. At block 650, one or more tracking points are selected or automatically established on each image. Typically, the tracking points are on a moving object. As indicated by circle H, the method of FIG. 42 continues to FIG. 43.

Continuing with FIG. 43, at block 652, the computing device 20 creates a surface or shell of the base model points using, for example, Delaunay's triangulation algorithm. Other methods of creating a surface or shell from a number of points are also applicable. Alternatively, the extracted features from other modules (e.g. modules 32, 34, 36, 38, 40, 42, 44) may be used to obtain the surface or shell. At block 654, for each image, using the pixel(s) associated with the tracking point(s) in the image, a line of sight is calculated from the pixel to the base model. The line of sight of the pixel in the image passes through the camera's perspective center onto the surface of the base model. The line of sight is calculated using known co-linearity equations and the IOP and the EOP. At block 656, where the line of sight of the pixel intersects the shell or surface of the base model, a new data point is created at that location. The new data point in the base model is four-dimensional and has the coordinated and the time stamp associated with the image (e.g. x, y, z, t).

At block 658, the dynamic and kinematic relationships are computed based on the collected data. It can be appreciated that the data can include a number of tracking points. There may be multiple moving objects in the images, such as multiple moving components in a robotic arm, and thus, it may be desirable to have multiple tracking points. For each tracking point, there may be a set four-dimensional coordinates. For example, for tracking point 1, tracking point 2, and tracking point n, there are corresponding four-dimensional coordinate sets 660, 662 and 664, respectively. This collected data can be used in a variety of known methods, including calculating velocity, average speed, acceleration, angular velocity, momentum, etc. The combination of the new four dimensional data points and the base model may be considered an enhanced base model.

In one example embodiment, if the positions of the base model data points are accurately known to within a fraction of an inch, then it is considered that movements of objects touching the model surface or immediately in front of the model surface can be accurately tracked and monitored over time by using tracking points.

Therefore in general, a method is provided for a computing device to track a moving object in a set of data points with three-dimensional spatial coordinates. The method comprises: the computing device obtaining a first image of the moving object, the first image comprising pixels and captured by a camera device; the computing device identifying a tracking point in the first image with a corresponding pixel; and the computing device adding a first data point corresponding in location and time to the tracking point in the first image. In another aspect, the first data point comprises a spatial coordinate and a time. In another aspect, adding a first data point corresponding in location and time to the tracking point comprises: obtaining one or more interior orientation parameters of the camera device; obtaining one or more exterior orientation parameters of the camera device; generating a triangulated surface using the set of data points; and projecting a line of sight from the pixel corresponding to the tracking point onto a location on the triangulated surface using at least one of the one or more interior orientation parameters and the one or more exterior orientation parameters, the location on the triangulated surface corresponding to the location of the tracking point. In another aspect, a Delaunay triangulation algorithm is used to form the triangulated surface. In another aspect, the method further comprises comparing the first data point with a second data point, the second data point corresponding to a location and time of the tracking point in a second image. In another aspect, the method further comprises calculating one or more kinematic relationships of the moving object using the first data point and the second data point.

It can be understood that the data having spatial coordinates 26, the extracted features 30, the base model 520, the enhanced base model 522, the four-dimensional data points, and the external data 524 can be perceived to be highly valuable. Information that is accurate and difficult to obtain, such as the obtained and derived or calculated data described herein, may be desired by many users. For example, users may wish to extract information from the data or manipulate the data for their own purposes to create derivatives of the data. The vendors of the data, that is those who process or sell the data, or both, often face a situation where they have to provide customers with portions of data, or samples of data. Ensuring that the data is not copied, or that the data derivatives are not freely created is difficult. In other words, once the vendor provides a user with the data, it is typically difficult to control how the data is used by the user.

In another scenario in the data vendor business, a data typically provides a potential customer with samples of data that might be purchased. However, providing a sample of data may not be desirable since it takes time and effort for the data vendor to produce and maintain suitable data samples, and the data sample can only partially represent the actual data set.

To address such issues, the proposed data licensing system described herein would be able to control the period of time that a user can use the data and its derivatives. In other words, the data vendor would be able to lease the data for a certain period of time, while ensuring that the data would be unusable when the time has expired. In this way, data vendors can provide data, such as complete sets of data, to users for a limited time with the reduced risk of the data being improperly used or stolen. It can also be appreciated that the principles of data licensing described below may apply to various types data beyond those described herein.

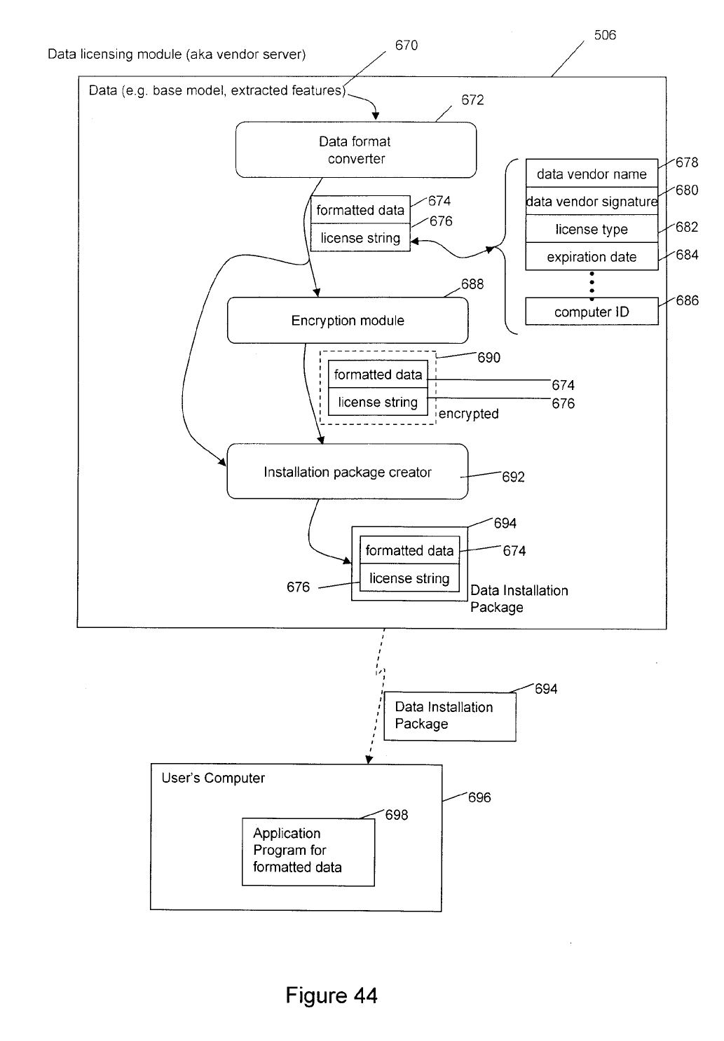

FIG. 44 shows an example configuration of a data licensing module 506, which may operate on the computing device 20 or some other computing device, such as a server belonging to a data vendor. The data licensing module 506 generates a data installation package 694 that is sent to a user's computer 696 via a CD, USB key, external hard drive, wireless data connection, etc.

In general, the data licensing module 506 includes a data format converter 672, an encryption module 688, and an installation package creator 692. Data format converter 672 obtains or receives data 670 (e.g. base model, extracted features, images, etc.) and converts the data 670 into a certain format. In other words, converter 672 generates formatted data 674 based on the inputted data 670. The converter 672 also generates a license 676 associated with the formatted data 674. The license 676, also referred to as a license string, includes different combinations of the data vendor name 678, the data vendor signature 680 (e.g. digital signatures as known in the field of cryptography), the license type 682 (e.g. permissions allowed to modify data, renewable or non-renewable license), the expiration date 684 of the license, and the computer ID 686 associated with the computer that has permission from the vendor to access the formatted data 674. It can be appreciated that the license 676 need not necessarily include all the above information. It can also be appreciated that there may be other types of information that can be included into the license 676.

The formatted data 674 and associated license 676 can then be encrypted by the encryption module 688, using various types of known encryption algorithms (e.g. RSA, ECMQV, MQV, asymmetric key algorithms, symmetric key algorithms, etc.). The encrypted data and license 690 is then transformed by the installation package creator 692 into a data installation package 694 using known software methods. In another embodiment, the formatted data 674 and license string 676 are not encrypted, but are rather configured by the installation package creator 692 to form the data installation package 694.

The installation package would be similar to many of those currently in the IT industry and would consist of an executable file which prompts the operator with instructions before proceeding to install a software program and auxiliary files in an operator defined location.

The data installation packaged 694 is then transmitted (e.g. over some storage device, over wires, over a wireless connection, etc.) and installed on the user's computer 696. The user's computer 696 stores an application program 698 that is configured to access formatted data 674. Where necessary, the application program 698 also includes a decryption module (not shown) to decrypt the encrypted data.

The data format used by this method must not be in an open form that can be easily read by 3rd party software. One example would be if the data is in a binary file format whose specifications are not openly disclosed, thus severely limiting the available software which can access the protected data. The data would be provided together with licensed software which is especially made available to access the data format and which must follow the data licensing method every time it accesses licensed data or its derivatives and which must automatically include the same protective licensing mechanism in each and every derivative which is created from the licensed data. An example configuration of the formatted data is Ambercore's “.isd” format and accompanying Ambercore software which has been designed to access the .isd data files.

Encryption mechanisms which cipher the actual data are not essential but can be included to enhance the security of the data licensing and further limit the possibilities of there being software available for unauthorized access to the data.

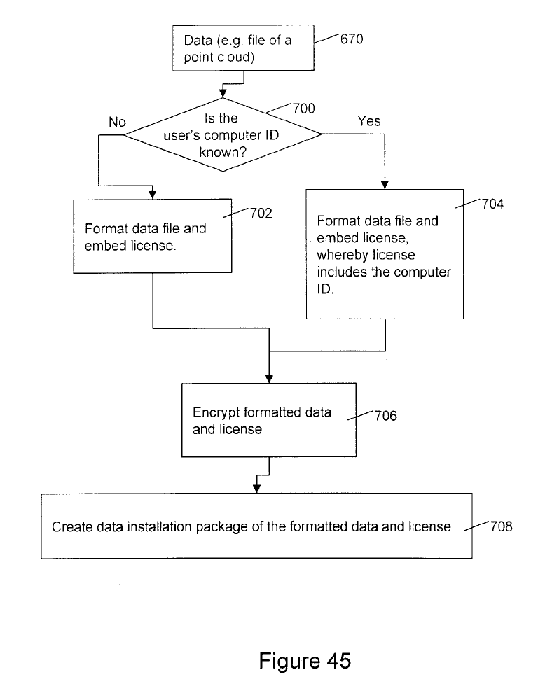

Turning to FIG. 45, example computer executable instructions are provided for the computing device 20, such as one belonging to a data vendor, for creating an installation package. At block 670, data is provided to the data licensing module 506. At block 700, the data licensing module 506 determines if the user's computer ID (e.g. IP address, operating system registration number, etc.) is known. If so, the licensing module 506 formats the data file and embeds the license, which includes the computer ID (block 704). If not, the data file is formatted and the license is embedded or associated with the data file (block 702), without inclusion of the computer ID. At block 706, the formatted data and license are encrypted. Then, a data installation package of the formatted data and license are created (block 708).

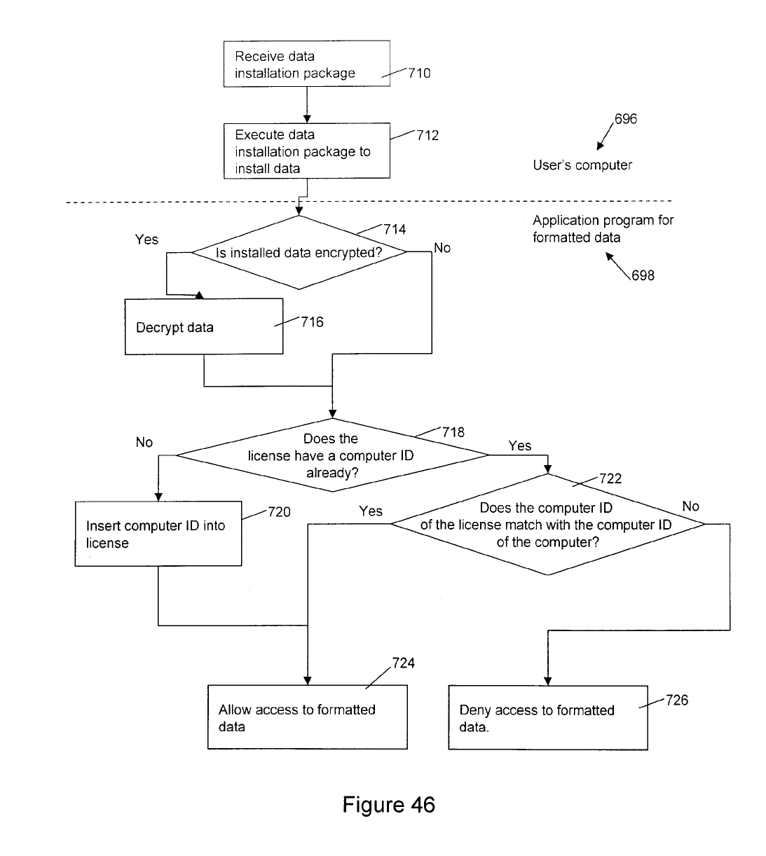

FIG. 46 provides example computer executable instructions for the user's computer 696 to allow access to the formatted data. At block 710, the user's computer 696 receives the data installation package, and then executes the data installation package to install the data (block 712). At block 714, the application program 698 reads the installed data and determines if the data is encrypted. If so, it is decrypted using known and appropriate algorithms (block 716). The application program 698 then determines if the license associated with the formatted data includes a computer ID (block 718). If not, at block 720, the application program 698 retrieves or receives a suitable computer ID associated with the user's computer 696 on which it is operating, and inserts the computer ID into the license. The application program 698 then allows access to the formatted data (block 724). However, if there is a computer ID associated already, then at block 722, it is determined if the computer ID of the license matches with the computer ID of the user's computer 696. If so, the access to the data is granted (block 724). If the computer IDs do not match, then access to the data is denied (block 726).

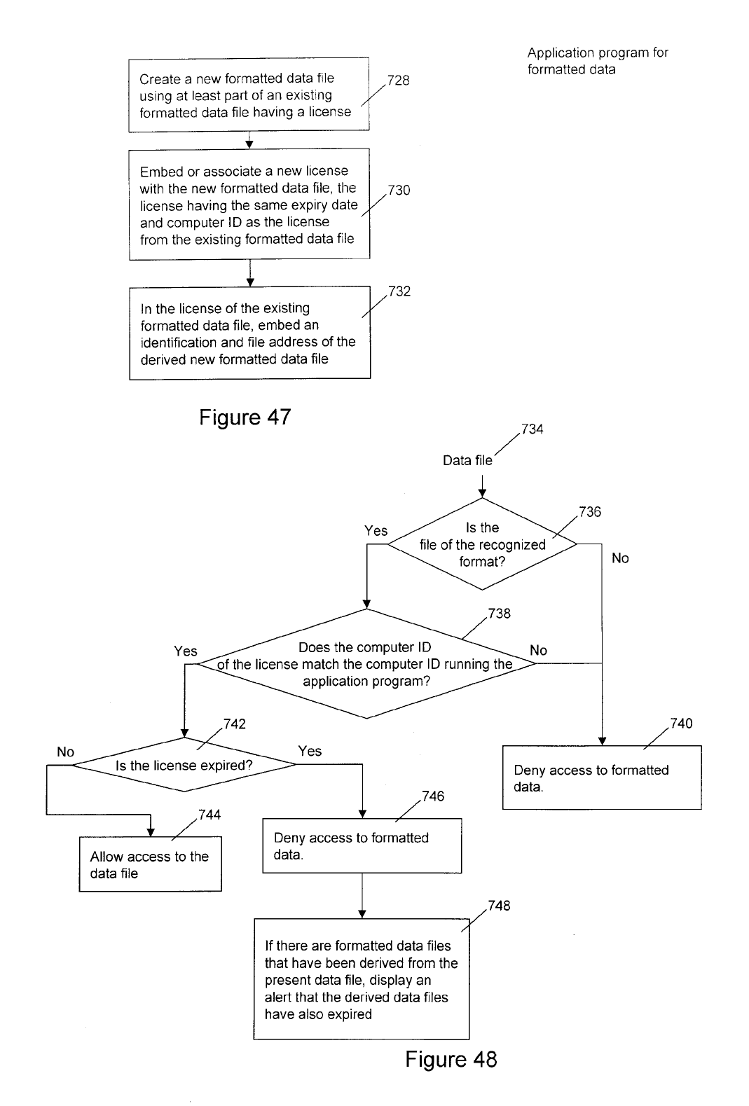

FIG. 47 provides example computer executable instructions for the application program 698 for creating licenses associated with data derivatives. In this way, the data derivatives have the same licensing conditions as the data from which it was derived. At block 728, the application program 698 creates a new formatted data file using at least part of an existing formatted data file, the existing formatted data file having its own license. At block 730, a new license is embedded or associated with the new formatted data file (e.g. the data derivative). The new license has the same expiry date and the same computer ID as the license from the existing formatted data file. At block 732, an identification and file address of the derived new formatted data file are embedded into or associated with the license of the existing formatted data file. In this way, as explained further below, there is a link between a formatted data file and its derivatives.

Turning to FIG. 48, example computer executable instructions are provided for the application program 698 to determine whether data should be accessed, based on a number of conditions. The application program 698 receives or obtains a data file 734. At block 736, it then determines whether the data file 734 is of the recognized format (e.g. .isd format). If not, then access to the file is denied (block 740). If the file is of the recognized format, then at block 738, it is determined if the computer ID of the license matches the user's computer ID. If not, then access is denied (block 740). If the computer IDs are verified, then at block 742, it is determined if the license has expired. If so, then access to the formatted data is denied (block 746). Further, if there are formatted data files that have been derived from the present data file, which can be determined based on the license information (see block 732), then the application program 698 displays an alert to the user that the derived data files have also expired. If the license has not expired, then access to the data file is allowed.

It can be appreciated that the application program 698 only reads data of the certain format specified by the vendor, only reads data and its derivatives if the license has not yet expired, only reads data licensed to the specified computer, and different combinations thereof. The application program 698 may prevent the export of data in other formats, in order to maintain control of the data and its derivatives. It can also be appreciated that there may be various warnings and alerts to communicate with the user that the expiry date is drawing close, or that the data has already expired. In some cases, the expired data may be automatically deleted. In other instances, the expired data will not be deleted, and can be accessed again upon renewing the licensing period.

Therefore, in general, a method is provided for licensing data between a vendor server having a vendor computing device and a user having a user computing device. The method comprises: the vendor computing device obtaining the data; the vendor computing device formatting the data; and the vendor computing device associating a license with the formatted data, the license including one or more criteria to permit access to the formatted data. In another aspect, the method further comprises the vendor computing device encrypting the formatted data and the associated license. In another aspect, the license includes an expiry date. In another aspect, the license includes identity information of one or more permitted users. In another aspect, the method further comprises: the user computing device obtaining the formatted data and the associated license; and the user computing device verifying the validity of the license by determining whether the one or more criteria are satisfied. In another aspect, the method further comprises: the user computing device generating new data using at least a portion of the formatted data; the user computing device formatting the new data; and the user computing device associating a new license with the new formatted data, the new license using at least a portion of the existing license.

It can be appreciated that the data from the point clouds may also be stored as objects in an objects database 521. As described earlier, an object comprises a number of data points, a wire frame, or a shell, and the object also has a known shape and known dimensions. The objects from the objects database 521 can also be licensed using the licensing module 506. The objects, for example, may be licensed and used in a number of ways, including referencing (e.g. for scaling different point clouds, for searching, etc.).

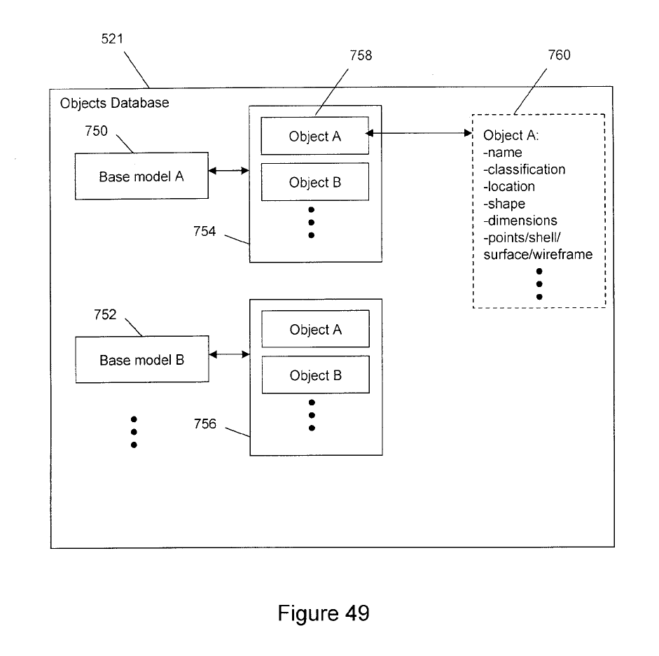

Turning to FIG. 49, an example configuration of an objects database 521 is provided. Generally, a group of objects are associated with a particular base model. Base model A (750) may be associated with a grouping of objects 758, while base model B (752) may be associated with another grouping of objects 756. Although not shown, there may also be objects that are not associated with a certain base model. Generally, as shown with respect to object A (760), an object may include a number of characteristics, such as a name, a classification, a location (e.g. coordinates within a base model), a shape, dimensions, etc. The object itself may be manifested in the form of a number data points having spatial coordinates, or a shell, or a wire frame, or combinations thereof. Such forms are known in various computer-aided design/drawing (CAD) systems. It can be appreciated that the shell or the wire frame can both be generated from the data points using known visual rendering techniques.

An example object could be a shell of a car, having the following characteristics: name=hybrid car model 123; classification=car; location=x,y,z in City of Toronto base model; etc. The shape and the dimensions of the car would be determined by the object's shell. It can be appreciated that there may be many different kinds of objects and classifications, which can be determined based on the application.

As discussed above, an object may be extracted according to the methods described herein. Alternatively, an object may be imported into the objects database 521 and associated with a base model. An object may also be manually identified within a base model, for example by a user selecting a number of data points and manually connecting lines between the points. Other known methods for extracting, creating, or importing objects can also be used.

The objects from the objects database 521 can be used in a number of ways, such as scaling a point cloud to have similar proportions with a base model (e.g. another point cloud). In particular, as described above with reference to FIG. 37, an external set of data points having spatial coordinates 528 (e.g. external point cloud) can be imported and geo-referenced relative to a base model using pairs of common points. Thus, the external point cloud can be transformed to match the base model, and then used to enhance the base model.

However, in some cases the external point cloud may not have any data points that are in common with a base model, or there may be an insufficient number of pairs of common data points to spatially scale and transform the external point cloud. Thus, the external point cloud cannot be transformed and geo-referenced to match the base model.

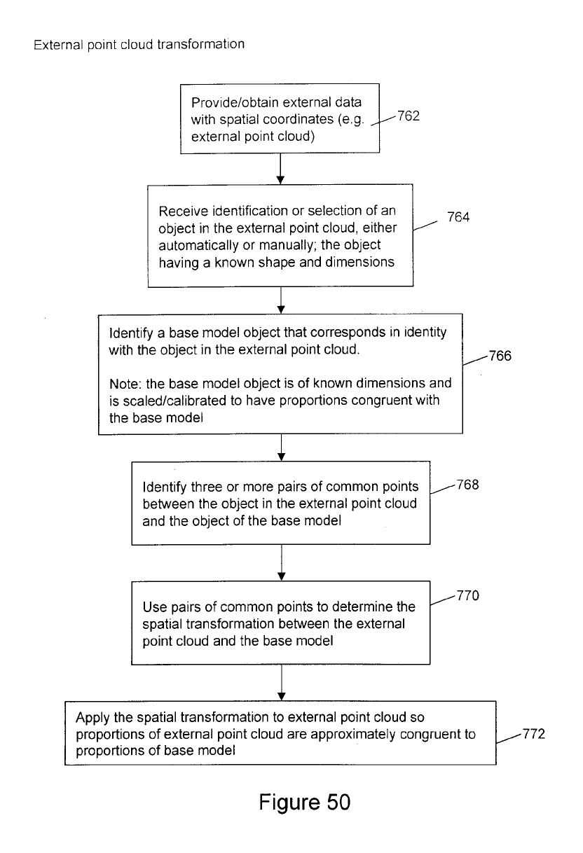

Turning to FIG. 50, example computer executable instructions are provided to at least spatially scale an external point cloud to have similar proportions to a base model, where an insufficient number of pairs of common data points are provided. Such instructions may be implemented by module 510. At block 762, an external point cloud is provided or obtained. At block 764, an object in the external point cloud is selected or identified, either automatically or manually. The object in the external point cloud should have a known shape and known dimensions. Non-limiting examples of an object would be a car of known make and model, a soda can of a known brand, a mail box of known dimensions, an architectural feature of a certain city, etc. The shape and dimensions of the object are preferably accurate, since they will be compared to the shape and dimensions of an object in the objects database 521.

Continuing with FIG. 50, at block 766 an object from the objects database 521 is selected or identified, either manually or automatically. The object, also referred to as the base model object, from the objects database 521 corresponds to the base model, whereby the external point cloud will be scaled to match proportions of the base model. The base model object corresponds with the object in the external point cloud, in that they are both known to have the same proportions. For example, if the object in the external point cloud is a car of a known make and model, the base model object is preferably also a car of the same make and model. The base model object, which is of known dimensions, should also be calibrated to have proportions congruent to the base model. In other words, if necessary, the base model object should have been previously calibrated and scaled to have proportions congruent with the base model before being associated with the base model.

Upon having identified the appropriate object from the external point cloud and the base model object, at block 768, three or more pairs of common points are identified between the two objects. At block 770, the pairs of common points are used to determine the spatial transformation between the external point cloud and the base model.

The spatial transformation is then applied to the external point cloud (block 770) so that the dimensions of the external point cloud are approximately sized to match the dimensions of the base model. In other words, objects that are common to the external point cloud and the base model should be the same size.

It is noted that the resulting transformation of the external point cloud may scale the data to match the base model in size, although may not necessarily result in geo-referenced data. However, by spatially transforming the external point cloud to match the base model, other valuable spatial information can be measured or extracted from the external point cloud.

Therefore, in general, a method is provided for a computing device to transform a first set of data points with three-dimensional spatial coordinates. The method comprises: the computing device selecting a first portion of the first set of data points, the first portion having a first property; the computing device obtaining a second set of data points with three-dimensional spatial coordinates; the computing device selecting a second portion of the second set of data points, the second portion having a second property; the computing device generating transformation information for transforming the first portion such that the first property is substantially equal to the second property of the second portion; and the computing device modifying the first set of data points using the transformation information. In another aspect, the first portion and the second portion correspond to a common object in the respective set of data points. In another aspect, modifying the first set of data points using the transformation information comprises applying the transformation information to the first set of data points such that the first property of the first portion is substantially equal to the second property of the second portion. In another aspect, the first property and second property correspond to one or more dimensions of the common object, the common object having a known shape and known dimensions. In another aspect, generating transformation information comprises identifying three or more data points in the first portion having a corresponding data point in the second portion. In another aspect, applying the transformation information comprises scaling.

The objects from the objects database 521 may also be used as a reference to search for similar-sized and similar-shaped objects in a point cloud, the point cloud being either geo-referenced or not. An example is to find all cars of a particular make and model in a point cloud using an object of the same car stored in the objects database 521.

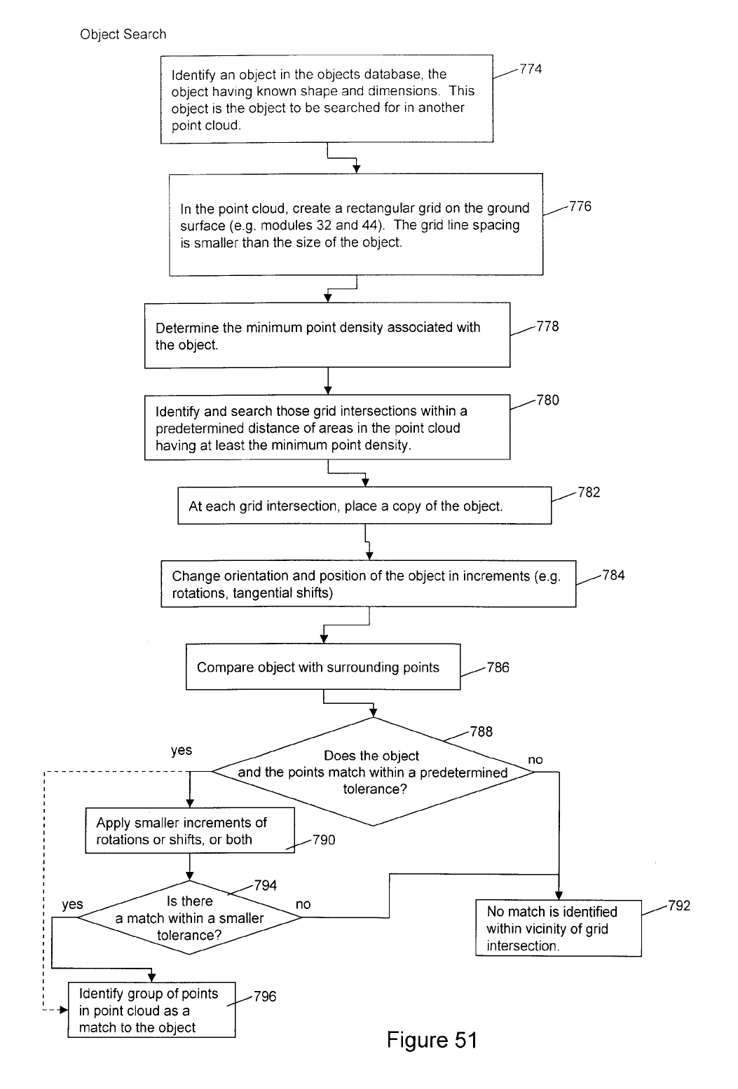

Turning to FIG. 51, example computer executable instructions are provided for searching for an object in a point cloud by comparing a subset of the data points to the object. Such instructions may be implemented by module 512. At block 774, an object is identified in the objects database 512. This object will be the reference used to find other similar object(s) in the point cloud. As can be understood, the object, also called the reference object, from the objects database 521, has a known shape and known dimensions. At block 776, a rectangular grid is created on the ground surface of the point cloud to be searched. It can be appreciated that the ground surface in a point cloud can be determined a number of ways, including manually and automatically (e.g. modules 32 and 44). The grid can be perceived as a “net” that canvasses the point cloud to catch the object being searched. Therefore, it is preferable to have the grid line spacing smaller than the size of the object being searched to ensure that the object, if present, can be found. For example, if searching for a car, it is desirable to have the grid line spacing to be one-fifth of the car's length.

At block 778, the minimum point density associated with the object is determined. The minimum point density may be determined using a variety of methods including empirical methods, statistical methods, or through user input. The point density is used as a parameter to narrow the search to areas in the point cloud having at least the minimum point density. The likelihood of finding an object similar to the reference object is increased when searching in areas having similar point densities. In particular, at block 780, the grid intersections that are located within a predetermined distance of areas having at least the minimum point density are identified and are searched. In one embodiment, these identified grid intersections are searched exclusively, or are searched first before searching other grid intersections. It is also appreciated that blocks 778 and 780 are optional. For example, an exhaustive search of all the grid intersections in the point cloud can be performed.

At block 782, at each grid intersection, the reference object is placed for comparison with the nearby data points in the point cloud. At block 784, the orientation and position of the reference object is changed in increments. At each increment (e.g. of the rotation or the shift, or both), the reference object is compared with the surrounding points (block 786). Note that at each grid intersection an initial approximate tilt of the object can be easily estimated using the angle between the vertical and the normal (perpendicular) vector to the ground surface (e.g. Bare Earth surface) at that grid intersection (for example if the car is on a hill it will be tilted approximately at that angle). At block 788, it is determined if the reference object and the surrounding points match within a predetermined tolerance (e.g. several feet in the case of a car). If not, then there is considered to be no match at the given grid intersection (block 792). If there is an approximate match, at block 790, smaller or finer increments of rotation and translation are applied to the reference object to determine if a closer match can be found between the subset of the data points and the object. At each increment, it is determined whether there is a match between the reference object and the surrounding points within a smaller tolerance (e.g. within several inches in the case of a car) (block 794). If a match is found, then the surrounding group of points, or those that correspond to the reference object, are identified as similar to the reference object (block 796). In other words, the search algorithm returns a positive result. If not, then no match is identified (block 792). In another embodiment, if there is a match within the first predetermined tolerance of block 788, then a positive match may be returned as per block 796, and as indicated by the dotted line.

Therefore, in general, a method is provided for a computing device to search for an object in a set of data points with three-dimensional spatial coordinates. The method comprises: the computing device comparing a subset of data points to the object; and the computing device identifying the subset of data points as the object if the subset of data points matches the object within a first tolerance. In another aspect, the method further comprises: the computing device applying a grid to the set of data points, the grid having a number of intersecting lines forming one or more grid intersections; and the computing device determining the minimum point density associated with the object; wherein the computing device compares the object to the subset of data points that includes grid intersections within a predetermined distance of areas having at least the minimum point density. In another aspect, the lines of the grid are spaced closer than a maximum dimension of the object. In another aspect, the method further comprises the computing device changing at least one of an orientation and a position of the object if the subset of data points does not match the object within the first tolerance. In another aspect, the method further comprises the computing device changing at least one of an orientation and a position of the object if the subset of data points matches the object within a second tolerance, the second tolerance being larger than the first tolerance. In another aspect, the method further comprises the computing device changing at least one of an orientation and a position of the object based on an orientation associated with the grid intersections within a predetermined distance of the subset of data points.

In another application, the objects database 521 can be used to identify or recognize an unidentified object in a point cloud. In general, an unidentified object is selected in a point cloud and then compared with various objects in the objects database 521 to find a match. If a positive match is identified, then the unidentified object is then identified as the matching object uncovered in the objects database 521.

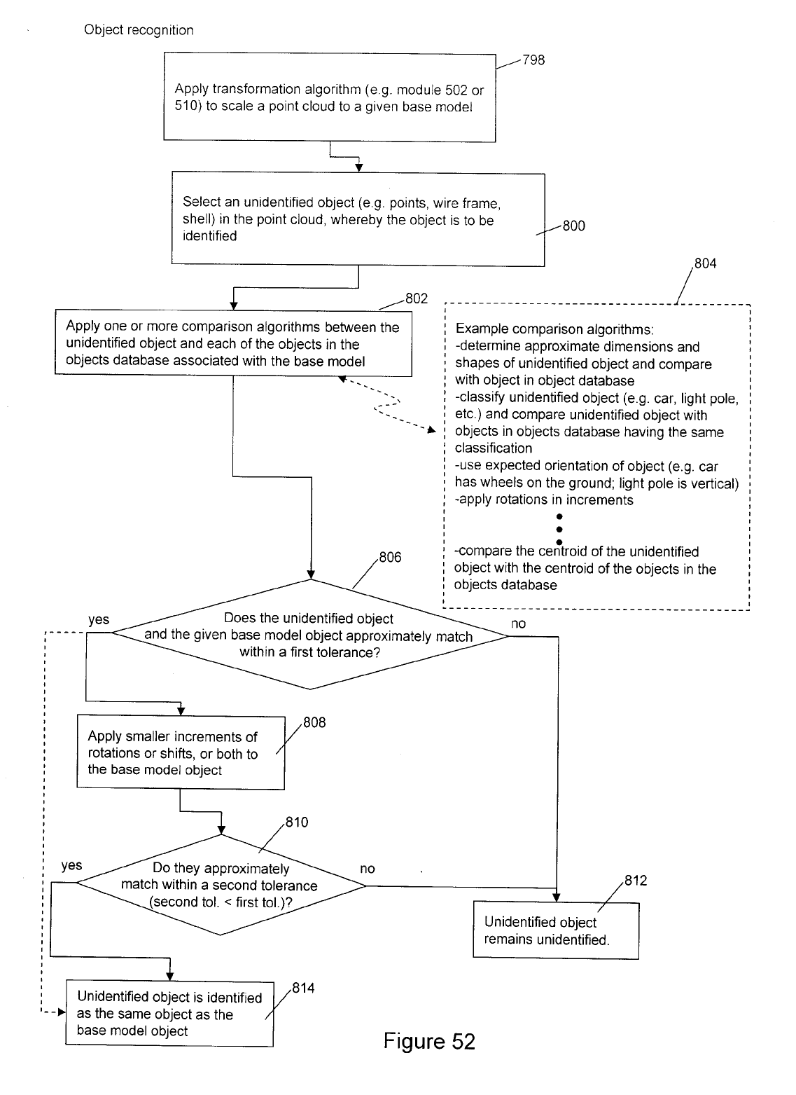

Turning to FIG. 52, example computer executable instructions are provided for recognizing an unidentified object. Such instructions can be implemented by module 514. In particular, at block 798, a transformation algorithm is applied to the point cloud to scale the point cloud to have similar proportions of given base model. The transformation algorithm can include those described with respect to module 502 or module 510. The point cloud and the base model are preferably of similar size in order to ensure that the unidentified object is of similar size or proportion to the various objects in the objects database 521. As described above, the various objects are scaled and associated with the given base model.

At block 800, an unidentified object in the point cloud is identified. The unidentified object may comprise a set of points, a wire frame or a shell. At block 802, one or more comparison algorithms are applied to compare the unidentified object against each of the objects in the objects database 521 that are associated with the given base model. Several algorithms may also be combined to determine whether the unidentified object matches a known object.

It can be appreciated that there are many object matching or recognitions algorithms, using 2D or 3D profiling, edge detection, pattern recognition, volume calculation, etc. and such algorithms can be used herein. Some example comparison algorithms are shown in block 804. In particular, the dimensions of the unidentified object can be determined and then compared with the dimensions of an object in the objects database 521. In another approach, a classification (e.g. car, light pole, furniture, etc.) may be associated with the unidentified object and then the classification may be used to narrow down the search to look for objects in the objects database 521 having the same classification. For example, if the unidentified object is known to be a car of some type, then all cars in the objects database 521 will be compared with the unidentified object. The expected orientation of the object may also be used. For example, if the object is generally known to be a car, it is expected to have wheels located on the ground. Similarly, a light pole should be in the vertical or upright position. In another comparison method, the unidentified object may be rotated in several different axes in an incremental manner, whereby at each increment, the unidentified object is compared against an object in the objects database 521. Another comparison method involves identifying the geometric centres of the objects, or the centroids, and comparing their location. Objects of the same shape will have centroids located in the same location.

Continuing with FIG. 52, at block 806, it is determined if the unidentified objects and the given base model object approximately match each other within a first tolerance. If not, the unidentified object remains unidentified (block 812). If so, at block 808, smaller increments of rotation or shifts, or both, are applied to determine if the unidentified object and the given base model object match. If they match within a second tolerance, whereby the second tolerance is less than the first tolerance (block 810), then the unidentified object is identified or recognized as the same object as the given base model object (block 814). If not, then the unidentified object remains unidentified (block 812).

In another embodiment, if at block 806 the unidentified object and a given base model object are matched within a first tolerance, then the unidentified object may be positively identified, as per block 814. This is shown by the dotted line.

Therefore, in general, a method is provided for a computer device to recognize a first object in a first set of data points with three-dimensional spatial coordinates. The method comprises: the computing device comparing a second object in a second set of data points to the first object; and the computing device identifying the first object as the second object if the first object matches the second object within a first tolerance. In another aspect, the method further comprises the computing device transforming the first set of data points to have similar proportions as the second set of data points. In another aspect, the method further comprises the computing device changing at least one of an orientation and a position of the second object if the first object does not match the second object within the first tolerance. In another aspect, the method further comprises the computing device changing at least one of an orientation and a position of the second object if the first object matches the second object within a second tolerance, the second tolerance being larger than the first tolerance. In another aspect, the method further comprises the computing device changing at least one of an orientation and a position of the second object based on an orientation associated with the first object. In another aspect, the first object is an unidentified object and the second object is a known object.

The above methods for searching for a particular object and for recognizing an unidentified object through comparison with objects in the objects database 521 can have many different applications. For example, an unidentified car can be selected in a point cloud and then identified by searching through all objects in the objects database 521 to determine the particular make and model of the car. In another example, a car of a particular make and model can be selected in the objects database, and then all instances of the car in the associated base model can be identified. In another example, the inside of an old shoe (e.g. an unidentified object) can be scanned using an energy system (e.g. LiDAR, sonar, infrared, etc.) and then compared with known dimensions of the insides of different new shoes. In this way, the new shoe having “inside” dimensions that most closely match the dimensions of the old shoe would be identified as the most comfortable fit for a user. In another example application, a person's body can be scanned (e.g. unidentified object) and the dimensions of the certain body parts, such as the waist, chest, neck, can be identified. Based on the identified measurements, a database of clothes of various sizes can used to find clothing that is sized to match the person's body. In another example, a chair can be scanned to generate a point cloud of the chair (e.g. an unidentified object). The point cloud of the chair is then compared against a database of chairs having known dimensions and shapes, in order to identify chairs of similar size, shape and structure. In another application, the comparison of an unidentified object to a known object can be used to determine deficiencies in the unidentified object. For example, if it is recognized that a light pole is leaning to the side, when the reference object is upright, then an alert is generated. In another example, if it is recognized that part of an unidentified car is dented as compared to a known car, then the dent in the unidentified car can be highlighted.

The above principles for extracting various features from a data point cloud P, for enhancing a base model with external data (e.g. images and other point clouds), for tracking movement in images, for licensing data, and for searching and referencing objects may be applied to a number of industries including, for example, mapping, surveying, architecture, environmental conservation, power-line maintenance, civil engineering, real-estate, building maintenance, forestry, city planning, traffic surveillance, animal tracking, clothing, product shipping, etc. The different software modules may be used alone or together to more quickly and automatically extract features from point clouds having large data sets, e.g. hundreds of millions or even billions of points. The different software modules can also be combined in a variety of ways, for example to store and license extracted features, base models, etc.

The steps or operations in the flow charts described herein are just for example. There may be many variations to these steps or operations without departing from the spirit of the invention or inventions. For instance, the steps may be performed in a differing order, or steps may be added, deleted, or modified.

While the basic principles of this invention or these inventions have been herein illustrated along with the embodiments shown, it will be appreciated by those skilled in the art that variations in the disclosed arrangement, both as to its details and the organization of such details, may be made without departing from the spirit and scope thereof. Accordingly, it is intended that the foregoing disclosure and the showings made in the drawings will be considered only as illustrative of the principles of the invention or inventions, and not construed in a limiting sense.

1. A method for a computing device to enhance a set of data points with three-dimensional spatial coordinates using an image captured by a camera device, the method comprising:
the computing device obtaining the image, the image comprising pixels, each of the pixels associated with a data value;
the computing device generating mapping information for associating one or more data points and one or more corresponding pixels; and
the computing device modifying the set of data points using the mapping information and the data values of the one or more corresponding pixels.

2. The method of claim 1, wherein generating mapping information comprises:
obtaining one or more interior orientation parameters of the camera device;
obtaining one or more exterior orientation parameters of the camera device; and
projecting a line of sight from the one or more data points onto the one or more corresponding pixels using at least one of the one or more interior orientation parameters and the one or more exterior orientation parameters.

3. The method of claim 1, wherein modifying the set of data points using the mapping information comprises associating one or more data points with the data value of the corresponding pixel.

4. The method of claim 1, wherein modifying the set of data points using the mapping information comprises:
adding a new data point for an existing data point, the existing data point being one of the one or more data points and having a corresponding pixel, the new data point having the same spatial coordinates as the existing data point; and
associating the new data point with the data value of the corresponding pixel.

5. The method of claim 1, wherein generating mapping information comprises:
obtaining one or more interior orientation parameters of the camera device;
obtaining one or more exterior orientation parameters of the camera device;
generating a triangulated surface using the set of data points; and
projecting a line of sight from one or more pixels onto one or more corresponding locations on the triangulated surface using at least one of the one or more interior orientation parameters and the one or more exterior orientation parameters.

6. The method of claim 5, wherein modifying the set of data points using the mapping information comprises:
adding a new data point to the set of data points, the new data point located at one of the one or more corresponding locations on the triangulated surface; and
associating the new data point with the data value of the pixel corresponding to the location of the new data point.

7. The method of claim 1, wherein modifying the set of data points using the mapping information comprises:
identifying one or more data points not having a corresponding pixel; and
modifying the one or more data points not having a corresponding pixel based on one or more data points associated with the data values of the one or more corresponding pixels.

8. The method of claim 7, wherein modifying the one or more data points not having a corresponding pixel comprises associating the one or more data points not having a corresponding pixel with information interpolated from the one or more data points associated with the data values of the one or more corresponding pixels.

9. The method of claim 1, wherein generating mapping information further comprises generating a base model of one or more data points corresponding to at least a portion of the image.

10. (canceled)

11. A method for a computing device to enhance a set of data points with three-dimensional spatial coordinates using a set of ancillary data points with three-dimensional spatial coordinates, the method comprising:
the computing device obtaining the set of ancillary data points, each ancillary data point associated with a data value;
the computing device generating mapping information for transforming the set of ancillary data points to be compatible with the set of data points; and
the computing device modifying the set of data points using the mapping information.

12. The method of claim 11, wherein generating mapping information comprises:
identifying three or more data points with a corresponding ancillary data point; and
obtaining a set of transformation parameters based on the three or more data points and the corresponding ancillary data points.

13. The method of claim 12, wherein the set of transformation parameters comprise x-translation, y-translation, z-translation, rotation about an x-axis, rotation about a y-axis, rotation about a z-axis, and a scale factor.

14. The method of claim 11, wherein modifying the set of data points using the mapping information comprises:
transforming one or more ancillary data points to be compatible with the set of data points using the mapping information; and
adding the transformed one or more ancillary data points to the set of data points.

15. The method of claim 11, wherein modifying the set of data points using the mapping information comprises:
transforming one or more ancillary data points to be compatible with the set of data points using the mapping information; and
associating one or more data points with information interpolated from one or more of the transformed ancillary data points.

16. The method of claim 11, wherein data points are associated with a different data type than the ancillary data points.

17. (canceled)

18. A method for a computing device to track a moving object in a set of data points with three-dimensional spatial coordinates, the method comprising:
the computing device obtaining a first image of the moving object, the first image comprising pixels and captured by a camera device;
the computing device identifying a tracking point in the first image with a corresponding pixel; and
the computing device adding a first data point corresponding in location and time to the tracking point in the first image.

19-24. (canceled)

25. A method of licensing data between a vendor server having a vendor computing device and a user having a user computing device, the method comprising:
the vendor computing device obtaining the data;
the vendor computing device formatting the data; and
the vendor computing device associating a licence with the formatted data, the licence including one or more criteria to permit access to the formatted data.

26-31. (canceled)

32. A method for a computing device to transform a first set of data points with three-dimensional spatial coordinates, the method comprising:
the computing device selecting a first portion of the first set of data points, the first portion having a first property;
the computing device obtaining a second set of data points with three-dimensional spatial coordinates;
the computing device selecting a second portion of the second set of data points, the second portion having a second property;
the computing device generating transformation information for transforming the first portion such that the first property is substantially equal to the second property of the second portion; and
the computing device modifying the first set of data points using the transformation information.

33-38. (canceled)

39. A method for a computing device to search for an object in a set of data points with three-dimensional spatial coordinates, the method comprising:
the computing device comparing a subset of data points to the object; and
the computing device identifying the subset of data points as the object if the subset of data points matches the object within a first tolerance.

40-45. (canceled)

46. A method for a computer device to recognize a first object in a first set of data points with three-dimensional spatial coordinates, the method comprising:
the computing device comparing a second object in a second set of data points to the first object; and
the computing device identifying the first object as the second object if the first object matches the second object within a first tolerance.

47-59. (canceled)
